(19) United States
(12) Patent Application Publication
(10) Pub. No.: US 2025/0277923 A1
(43) Pub. Date: Sep. 4, 2025

(54) MOLDED PRISM, CAMERA MODULE AND ELECTRONIC DEVICE

(71) Applicant: LARGAN PRECISION CO., LTD., Taichung City (TW)

(72) Inventors: Pei-Chi CHANG, Taichung City (TW); Yu-Chen LAI, Taichung City (TW)

(21) Appl. No.: 19/021,514

(22) Filed: Jan. 15, 2025

(30) Foreign Application Priority Data
Feb. 29, 2024 (TW) 113107328

(51) Int. Cl. G02B 5/04

(52) U.S. Cl. CPC G02B 5/04

(57) ABSTRACT

A molded prism includes an optical body and a sheet shading element. The optical body has a light path passing through the optical body, and includes a reflecting surface and a gate trace. The sheet shading element is covered via the optical body, and the sheet shading element includes a first surface, a second surface and a first light blocking structure. The second surface is relative to the first surface, and the first light blocking structure includes a first periphery that is connected to the first surface and the second surface. The first periphery includes a plurality of light blocking petals, and the light blocking petals are adjacent arranged. Each of the light blocking petals of the first periphery includes a tapered portion tapering towards a direction close to the light path, and the light blocking petals are covered inside the optical body.

### RELATED APPLICATIONS

This application claims priority to Taiwan Application Serial Number 113107328, filed Feb. 29, 2024, which is herein incorporated by reference.

### BACKGROUND

### Technical Field

The present disclosure relates to a molded prism and a camera module. More particularly, the present disclosure relates to a molded prism and a camera module applicable to portable electronic devices.

### Description of Related Art

In recent years, portable electronic devices have developed rapidly. For example, intelligent electronic devices and tablets have been filled in the lives of modern people, and camera modules and molded prisms thereof mounted on portable electronic devices have also prospered.

However, as technology advances, the quality requirements of the molded prism are becoming higher and higher. In particular, the unpredicted reflection is easily occurred inside of the molded prism owing to the light folding in the molded prism, so that the flare is caused. Therefore, a molded prism, which can solve the light blocking problem, needs to be developed.

### SUMMARY

According to one aspect of the present disclosure, a molded prism includes an optical body and a sheet shading element. The optical body has a light path passing through the optical body, and includes a reflecting surface and a gate trace. The light path is folded on the reflecting surface, and the light path does not pass through the gate trace. The sheet shading element is covered via the optical body, the sheet shading element is closer to the light path than the gate trace to the light path, and the sheet shading element includes a first surface, a second surface and a first light blocking structure. The second surface is relative to the first surface, and the second surface is farther away from the reflecting surface than the first surface from the reflecting surface. The first light blocking structure includes a first periphery that is connected to the first surface and the second surface, the first periphery faces towards the light path, the first periphery surrounds the light path, and the optical body is physically contacted with the first periphery, the first surface and the second surface. The first periphery includes a plurality of light blocking petals, a number of the light blocking petals of the first periphery is between 14 and 250, and the light blocking petals are adjacent arranged. Each of the light blocking petals of the first periphery includes a tapered portion tapering towards a direction close to the light path, and the light blocking petals are covered inside the optical body.

According to one aspect of the present disclosure, a camera module includes the molded prism of the aforementioned aspect.

According to one aspect of the present disclosure, an electronic device includes the camera module of the aforementioned aspect.

According to one aspect of the present disclosure, a molded prism includes an optical body and a sheet shading element. The optical body has a light path passing through the optical body, and includes a reflecting surface and a gate trace. The light path is folded on the reflecting surface, and the light path does not pass through the gate trace. The sheet shading element is covered via the optical body, the sheet shading element is closer to the light path than the gate trace to the light path, and the sheet shading element includes a first surface, a second surface and a first light blocking structure. The second surface is relative to the first surface, and the second surface is farther away from the reflecting surface than the first surface from the reflecting surface. The first light blocking structure includes a first periphery that is connected to the first surface and the second surface, the first periphery faces towards the light path, the first periphery surrounds the light path, and the optical body is physically contacted with the first periphery, the first surface and the second surface. The optical body further includes a release structure disposed on a side of the sheet shading element away from the first periphery, and the release structure is tapered along an extending direction of the sheet shading element. At least one portion of the sheet shading element is disposed on the release structure.

### BRIEF DESCRIPTION OF THE DRAWINGS

FIG. 1A is a three-dimensional view of a molded prism according to the 1st example of the present disclosure.

FIG. 1B is a partial enlarged view of the molded prism according to the 1st example in FIG. 1A.

FIG. 1C is a top view of the molded prism according to the 1st example in FIG. 1A.

FIG. 1D is a partial enlarged view of the molded prism according to the 1st example in FIG. 1C.

FIG. 1E is a side view of the molded prism according to the 1st example in FIG. 1A.

FIG. 1F is a cross-sectional view of the molded prism according to the 1st example in FIG. 1E.

FIG. 1G is a partial enlarged view of the molded prism according to the 1st example in FIG. 1F.

FIG. 1H is another partial enlarged view of the molded prism according to the 1st example in FIG. 1F.

FIG. 1I is a reflectance diagram of an anti-reflecting surface according to the 1st example in FIG. 1A.

FIG. 1J is a transmittance diagram of the molded prism according to the 1st example in FIG. 1A.

FIG. 1K is another transmittance diagram of the molded prism according to the 1st example in FIG. 1A.

FIG. 2A is a three-dimensional view of a molded prism according to the 2nd example of the present disclosure.

FIG. 2B is a schematic view of the molded prism according to the 2nd example in FIG. 2A.

FIG. 2C is a top view of the molded prism according to the 2nd example in FIG. 2A.

FIG. 2D is a partial enlarged view of the molded prism according to the 2nd example in FIG. 2C.

FIG. 2E is a cross-sectional view of the molded prism according to the 2nd example in FIG. 2A.

FIG. 2F is a partial enlarged view of the molded prism according to the 2nd example in FIG. 2E.

FIG. 3A is a three-dimensional view of a molded prism according to the 3rd example of the present disclosure.

FIG. 3B is a partial enlarged view of the molded prism according to the 3rd example in FIG. 3A.

FIG. 3C is a side view of the molded prism according to the 3rd example in FIG. 3A.

FIG. 3D is a top view of the molded prism according to the 3rd example in FIG. 3A.

FIG. 3E is a partial enlarged view of the molded prism according to the 3rd example in FIG. 3D.

FIG. 3F is a cross-sectional view of the molded prism according to the 3rd example in FIG. 3A.

FIG. 3G is a partial enlarged view of the molded prism according to the 3rd example in FIG. 3F.

FIG. 4A is a three-dimensional view of a molded prism according to the 4th example of the present disclosure.

FIG. 4B is a partial enlarged view of the molded prism according to the 4th example in FIG. 4A.

FIG. 4C is a top view of the molded prism according to the 4th example in FIG. 4A.

FIG. 4D is a cross-sectional view of the molded prism according to the 4th example in FIG. 4A.

FIG. 4E is a partial enlarged view of the molded prism according to the 4th example in FIG. 4D.

FIG. 4F is a cross-sectional schematic view of the molded prism along line 4F-4F in FIG. 4D.

FIG. 4G is a partial enlarged view of the molded prism according to the 4th example in FIG. 4F.

FIG. 5A is a three-dimensional view of a molded prism according to the 5th example of the present disclosure.

FIG. 5B is a top view of the molded prism according to the 5th example in FIG. 5A.

FIG. 5C is a partial enlarged view of the molded prism according to the 5th example in FIG. 5B.

FIG. 5D is a cross-sectional view of the molded prism according to the 5th example in FIG. 5A.

FIG. 5E is another cross-sectional view of the molded prism according to the 5th example in FIG. 5A.

FIG. 5F is a partial enlarged view of the molded prism according to the 5th example in FIG. 5E.

FIG. 6A is a three-dimensional view of a molded prism according to the 6th example of the present disclosure.

FIG. 6B is a side view of the molded prism according to the 6th example in FIG. 6A.

FIG. 6C is a partial enlarged view of the molded prism according to the 6th example in FIG. 6B.

FIG. 6D is another side view of the molded prism according to the 6th example in FIG. 6A.

FIG. 6E is a partial enlarged view of the molded prism according to the 6th example in FIG. 6D.

FIG. 6F is a cross-sectional view of the molded prism according to the 6th example in FIG. 6A.

FIG. 6G is a partial enlarged view of the molded prism according to the 6th example in FIG. 6F.

FIG. 7A is a three-dimensional view of a molded prism according to the 7th example of the present disclosure.

FIG. 7B is a partial enlarged view of the molded prism according to the 7th example in FIG. 7A.

FIG. 7C is a top view of the molded prism according to the 7th example in FIG. 7A.

FIG. 7D is a partial enlarged view of the molded prism according to the 7th example in FIG. 7C.

FIG. 7E is a side view of the molded prism according to the 7th example in FIG. 7A.

FIG. 7F is a cross-sectional view of the molded prism according to the 7th example in FIG. 7E.

FIG. 7G is a partial enlarged view of the molded prism according to the 7th example in FIG. 7F.

FIG. 8 is a schematic view of a camera module according to the 8th example of the present disclosure.

FIG. 9 is a schematic view of a camera module according to the 9th example of the present disclosure.

FIG. 10 is a schematic view of a camera module according to the 10th example of the present disclosure.

FIG. 11 is a schematic view of a camera module according to the 11th example of the present disclosure.

FIG. 12A is a schematic view of an electronic device according to the 12th example of the present disclosure.

FIG. 12B is another schematic view of the electronic device according to the 12th example in FIG. 12A.

FIG. 13 is a schematic view of an electronic device applied to a computer according to the 13th example of the present disclosure.

FIG. 14 is a schematic view of an electronic device applied to a wearable device according to the 14th example of the present disclosure.

### DETAILED DESCRIPTION

The present disclosure provides a molded prism, which includes an optical body and a sheet shading element, wherein the optical body has a light path passing through the optical body, and the sheet shading element is covered via the optical body. The optical body includes a reflecting surface and a gate trace, wherein the light path is folded on the reflecting surface, the light path does not pass through the gate trace, and a number of the reflecting surface can be plurality. The sheet shading element is closer to the light path than the gate trace to the light path, and the sheet shading element includes a first surface, a second surface and a first light blocking structure, wherein the second surface is relative to the first surface, and the second surface is farther away from the reflecting surfaces than the first surface from the reflecting surfaces. The first light blocking structure includes a first periphery, wherein the first periphery is connected to the first surface and the second surface, the first periphery faces towards the light path, the first periphery surrounds the light path, and the optical body is physically contacted with the first periphery, the first surface and the second surface.

By the sheet shading element being closer to the light path than the gate trace to the light path, the flare, which is formed owing to the light via the plastic gate trace, can be avoided, so that the optical quality can be ensured, wherein the aforementioned structure of the sheet shading element can be further formed by the manufacturing process, such as the sheet metal process, the stamping process, the laser process and the etching process, but the present disclosure is not limited thereto. Further, the internal light blocking structure is formed by the optical body being physically contacted with the first periphery, and the internal light blocking structure is simultaneously and physically contacted with the first surface and the second surface, so that the combination of the sheet shading element and the optical body can be ensured.

In detail, the optical body can be made of transparent material, such as plastic material and glass material, so that the optical body can further obtain the function of absorbing and filtering the light with the specific wavelength. The gate trace is the trace of the optical body flowing during the manufacturing process, the specific spatial geometric features of the gate trace are formed by the mold and the post-processing, and the gate trace can also be a flow mark, a sink mark and a void, but the idiomatic expression is not limited thereto, wherein the aforementioned spatial geometric features can be the shape of the injection channel, the shape of the shearing, the shape of the flash, but the present disclosure is not limited thereto. The first periphery of the first light blocking structure can be closed and surround the light path or be opened and surround the light path.

The first periphery can include a plurality of light blocking petals, wherein a number of the light blocking petals of the first periphery can be between 14 and 250, and the light blocking petals are adjacent arranged, so that the effectiveness of the sheet shading element can be ensured. Moreover, each of the light blocking petals of the first periphery can include a tapered portion tapering towards a direction close to the light path, and the light blocking petals are covered inside the optical body, so that the vignetting of the periphery can be smoothly transited for enhancing the imaging quality.

The optical body can further include a release structure disposed on a side of the sheet shading element away from the first periphery, the release structure is tapered along an extending direction of the sheet shading element, and at least one portion of the sheet shading element is disposed on the release structure. By the design of disposing the sheet shading element on the release structure, the manufacturing stability can be enhanced, and the shifting of the sheet shading element can be reduced, so that the yield rate can be enhanced. Furthermore, the metal light blocking sheet can be fixed in the specific position during the embedded injection process by the release structure, so that the shifting of the light blocking sheet can be reduced to further ensure the optical quality.

The sheet shading element can further include a cutting mark farther away from the light path than the first periphery from the light path, and the cutting mark exposes on the optical body. Therefore, the stability of the sheet shading element during the manufacturing process can be enhanced. Further, the cutting mark can be further and physically contacted with the gate trace, and the sheet shading element and the optical body can be finished cutting once so as to enhance the manufacturing efficiency.

The optical body can further include an incident surface and an exit surface, wherein the light path passes through the incident surface, the reflecting surface and the exit surface in sequence, and the sheet shading element extends along a direction away from one of the incident surface, the reflecting surface and the exit surface. Therefore, the forming quality of the optical surface and the shifting amount of the light blocking structure can be simultaneously considered by cooperating the extending direction of the sheet shading element with the optical surface, so that the optical quality can be enhanced and ensured. Further, the optical quality can be improved by cooperating the release direction with optical surface. Moreover, the aforementioned direction can be perpendicular to one of the incident surface, the reflecting surface and the exit surface so as to simplify the design and improve the efficiency of the quality control, and the release structure is tapered on the aforementioned direction to further cooperate the release direction with the optical surface, so that the optical quality can be enhanced.

The optical body can further include a ridge structure, wherein the ridge structure can include a plurality of recesses arranged along a direction surrounding the light path, each of the recesses can include a recess end, the recess end is corresponding to the first periphery of the first light blocking structure, and each of the recesses is gradually widened from the recess end towards a direction away from the light path. Therefore, the better optical quality can be achieved by cooperating the first periphery with the multiple times of the light blocking. Furthermore, the release structure can include the ridge structure.

The molded prism can further include an opaque layer disposed on the ridge structure. Therefore, the function of blocking the light of the ridge structure can be further enhanced so as to improve the light blocking quality.

The ridge structure can further include a plurality of ribs, wherein the ribs extend from the recesses towards a direction away from the light path. Therefore, the anti-reflecting ability of the optical body can be further enhanced.

The sheet shading element can further include at least one bending portion, wherein at least one portion of the first periphery is disposed on the bending portion. Therefore, the light from the different directions can be blocked, and the mechanical property of the sheet shading element can be enhanced via the bending portion so as to improve the manufacturing process.

The sheet shading element can further include a second light blocking structure, and the second light blocking structure can include a second periphery, wherein the second periphery is connected to the first surface and the second surface, the second periphery faces towards the light path, the second periphery surrounds the light path, and the second periphery and the optical body are physically contacted. The second periphery can include a plurality of light blocking petals, wherein a number of the light blocking petals of the second periphery is between 14 and 250, and the light blocking petals are adjacently arranged. Each of the light blocking petals of the second periphery can include a tapered portion tapering towards a direction close to the light path, and the light blocking petals are covered inside of the optical body. By simultaneously providing multiple of the light blocking structures via the sheet shading element, the elements can be reduced so as to lower the assembling cost.

A number of the sheet shading element can be plurality. Therefore, the degree of freedom of the light blocking type of the molded prism can be enhanced, so that the optical requirements can be satisfied.

A thickness of each of the light blocking petals can gradually increase towards a direction away from the light path. Therefore, the moldability can be ensured.

The light path can be folded at least twice occurring in the optical body. Therefore, the spatial utilization of an electronic device used a camera module with the prism can be enhanced.

The molded prism can further include an exposed structure, wherein the sheet shading element is exposed on the exposed structure to the optical body, and the release structure is tapered on a direction away from the exposed structure. Therefore, the demolding process can be stable so as to avoid the molding defects.

The tapered portion of each of the light blocking petals is tapered towards the direction close to the light path to form a rear portion. When a distance between adjacent two of the rear portions is D1, the following condition can be satisfied: 0.018 mm≤D1≤0.8 mm. Therefore, the peripheral quality can be further enhanced. Moreover, the rear portion can be a tip, an arc or a plane, but the present disclosure is not limited thereto. Further, the following condition can be satisfied: 0.02 mm≤D1≤0.6 mm.

When a thickness of the sheet shading element is defined via a distance between the first surface and the second surface, and the thickness of the sheet shading element is T, the following condition can be satisfied: 0.03 mm≤T≤0.5 mm. Therefore, the balance between the manufacturing process and the optical quality can be obtained so as to ensure the manufacturing feasibility.

The release structure can include a first release surface, wherein the first release surface is gradually close to the sheet shading element along the extending direction of the sheet shading element. When a minimum distance between the first release surface and the sheet shading element is G1, the following condition can be satisfied: 0.02 mm≤G1≤0.32 mm. Further, the following condition can be satisfied: 0.03 mm≤G1≤0.24 mm. Moreover, the release surface can be a plane, an arc surface or a curved surface, but the present disclosure is not limited thereto.

The release structure can further include a second release surface, wherein the second release surface is relative to the first release surface, and the sheet shading element is disposed between the first release surface and the second release surface. When a minimum distance between the first release surface and the second release surface is G12; a thickness of the sheet shading element is defined via a distance between the first surface and the second surface, and the thickness of the sheet shading element is T, the following condition can be satisfied: 0.12≤T/G12≤0.91. Therefore, the effect of the release structure can be further enhanced. Further, the following condition can be satisfied: 0.15≤T/G12≤0.68.

When a distance between adjacent two of the recess ends is D2, the following condition can be satisfied: 0.028 mm≤D2≤0.6 mm. Further, the following condition can be satisfied: 0.038 mm≤D2≤0.45 mm.

The optical body can further include an anti-reflecting surface, wherein the light path passes through the anti-reflecting surface, and a maximum reflectivity of the anti-reflecting surface in a wavelength range of 450 nm to 750 nm is less than or equal to 0.49%. Therefore, the transmittance can be enhanced so as to improve the optical quality. Furthermore, the surface reflectivity of the anti-reflecting surface can be reduced by disposing an anti-reflecting layer and a microstructure layer, but the present disclosure is not limited thereto.

An infrared light is partially filtered via the molded prism, and a wavelength providing a transmittance of the molded prism being 50% can be between 600 nm and 700 nm. Therefore, the optical quality can be enhanced by filtering the light with the specific range of the wavelength. Further, the aforementioned purpose of the molded prism can be achieved by disposing the coating layer, disposing the optical body with the absorbing property of the infrared light or simultaneously multiple filtering methods.

Each of the aforementioned features of the molded prism can be utilized in various combinations for achieving the corresponding effects.

The present disclosure provides a camera module, which includes the aforementioned molded prism.

The camera module can further include a carrier, wherein at least one portion of the carrier is disposed on the exposed structure. Therefore, the combination between the carrier and the molded prism can be enhanced so as to reduce the defective rate.

Each of the aforementioned features of the camera module can be utilized in various combinations for achieving the corresponding effects.

The present disclosure provides an electronic device, which includes the aforementioned camera module. Furthermore, the electronic device can further include an image sensor module and a flash module, but the present disclosure is not limited thereto.

According to the aforementioned embodiment, specific examples are provided, and illustrated via figures.

### 1st Example

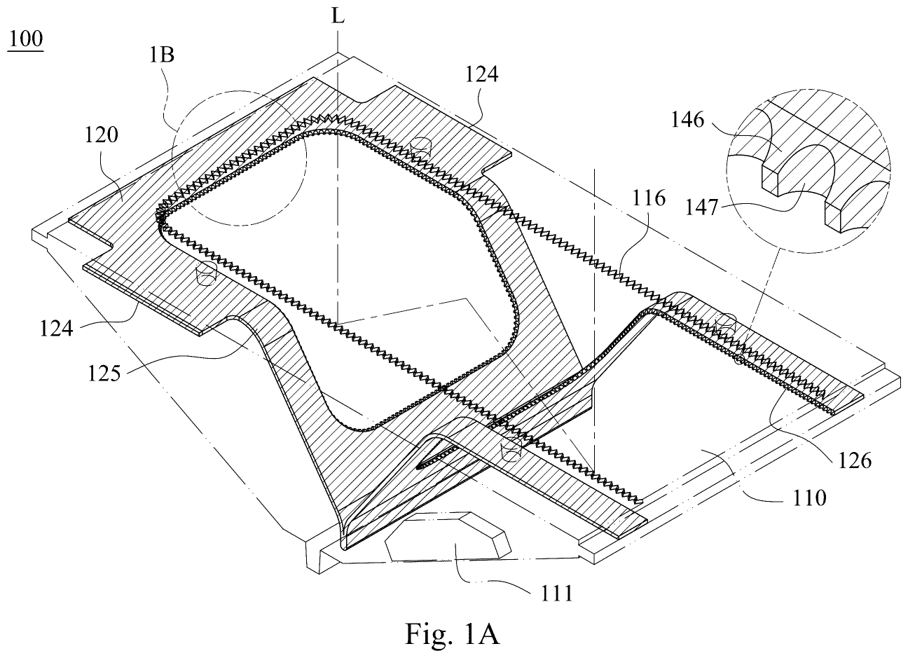

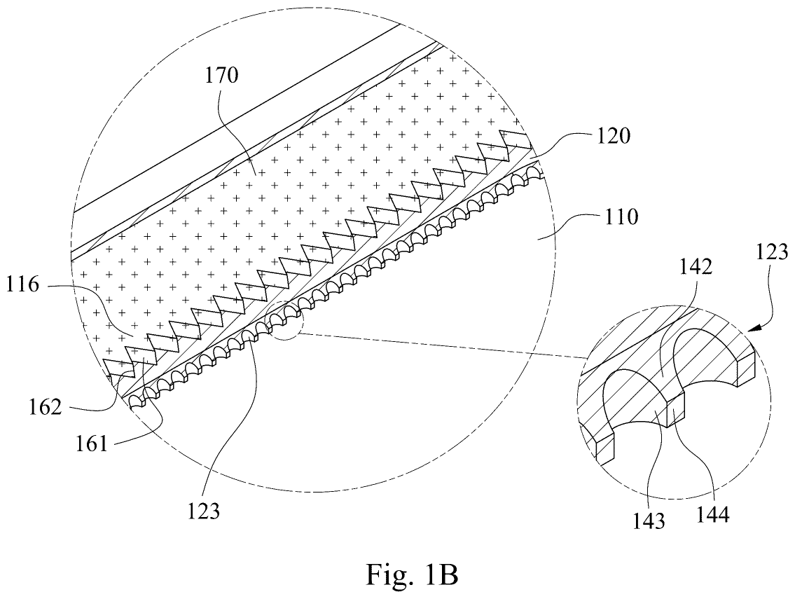

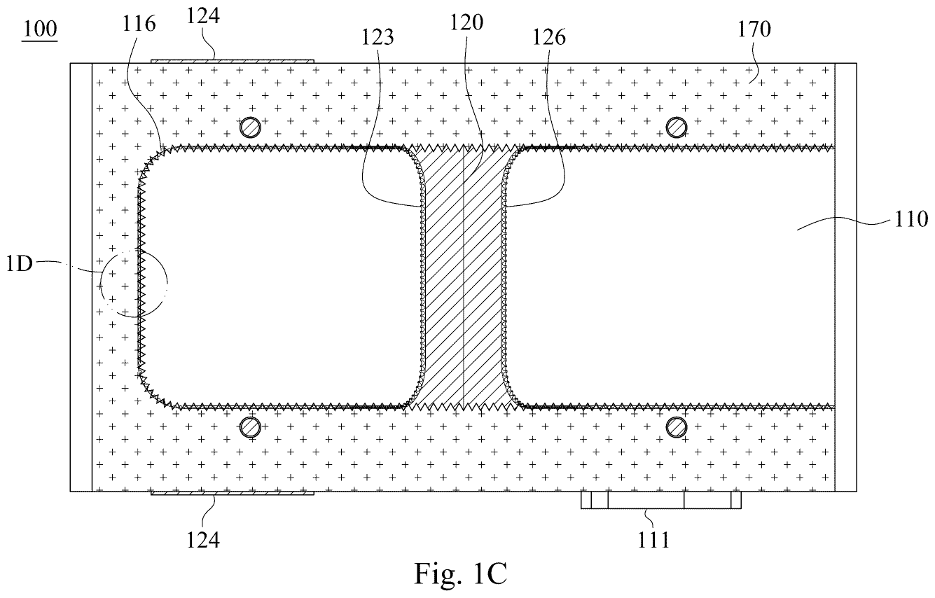

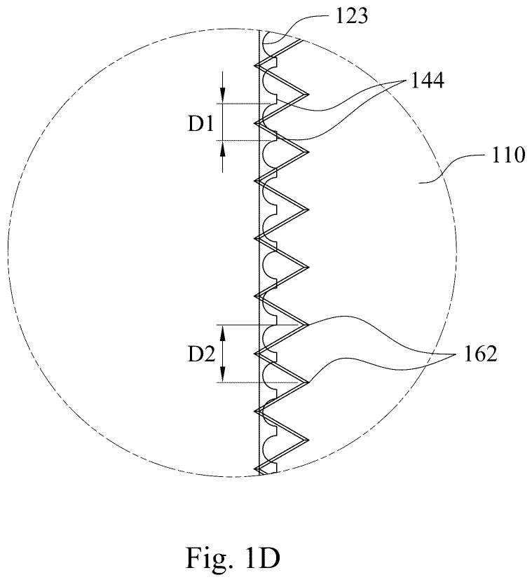

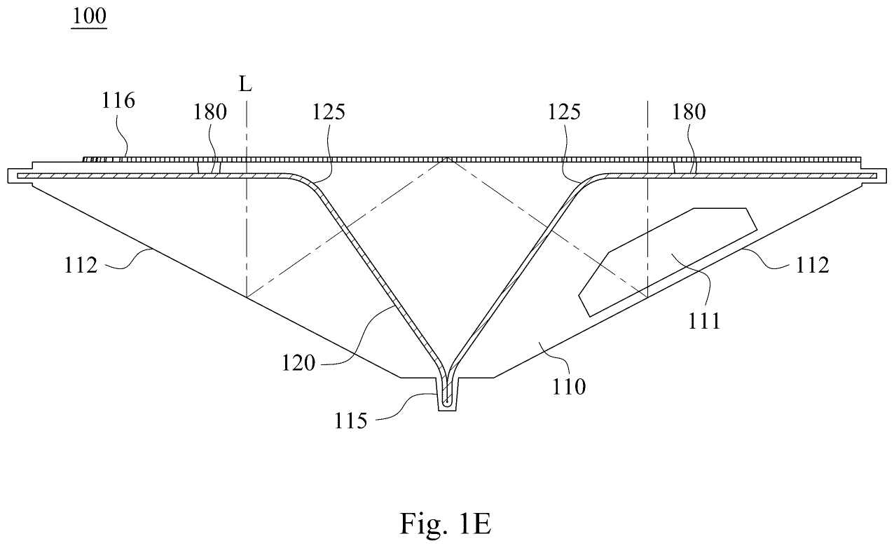

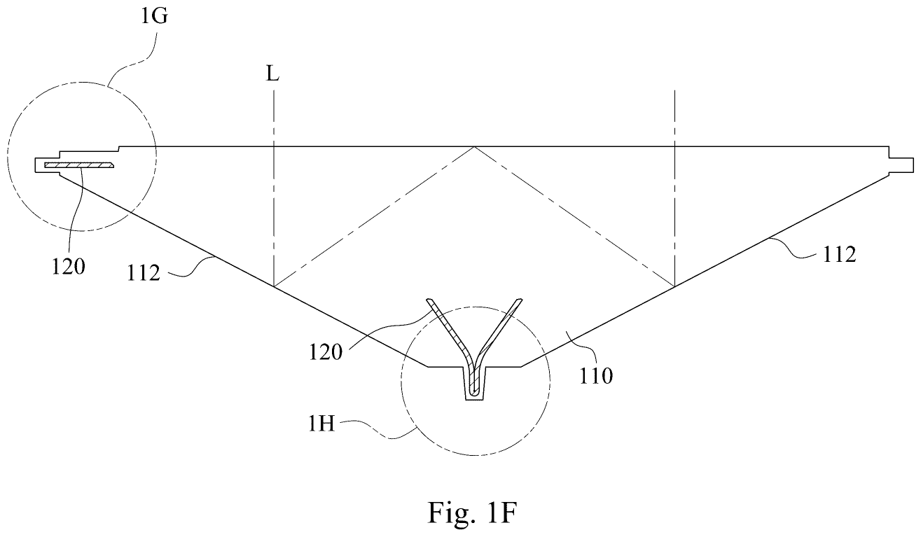

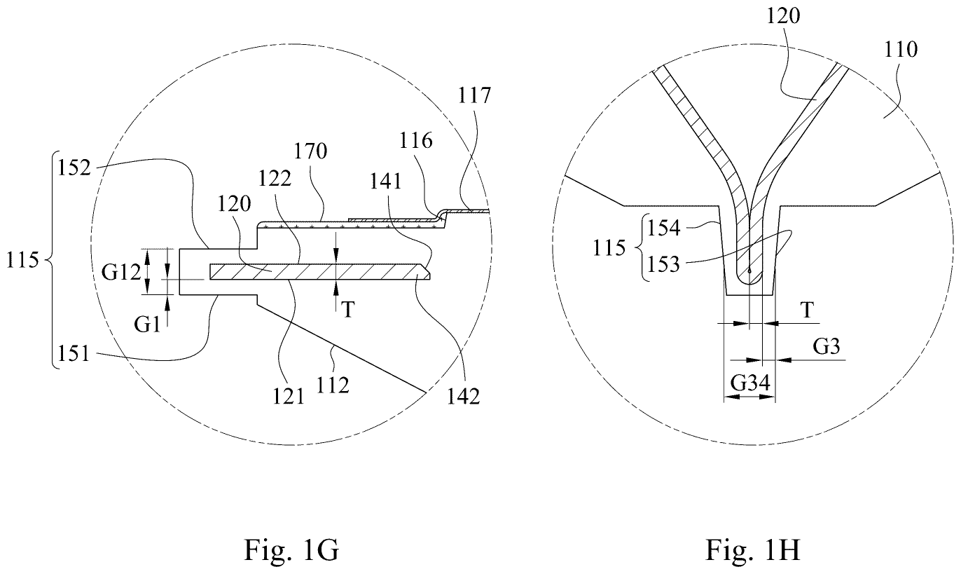

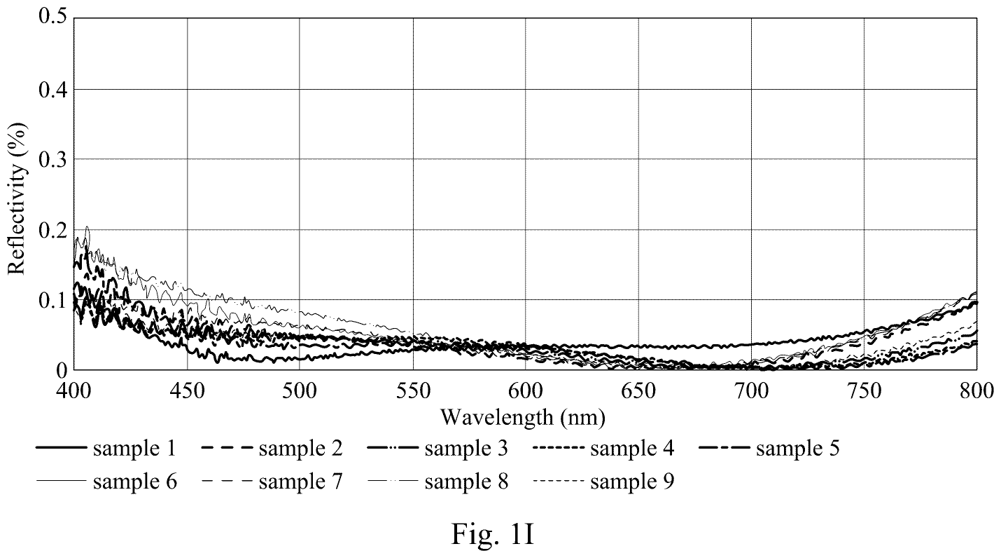

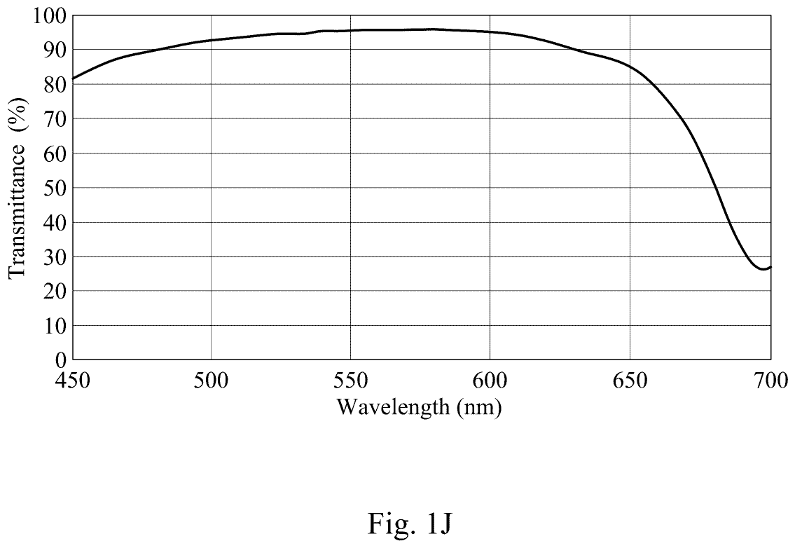

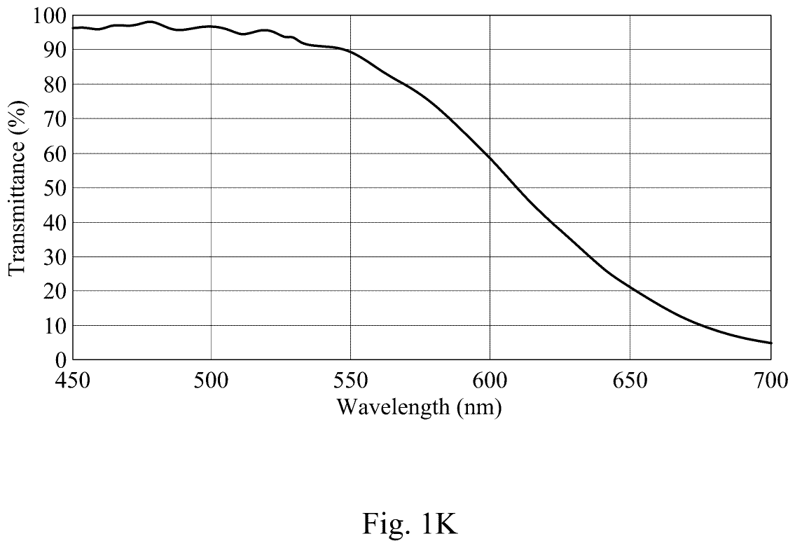

FIG. 1A is a three-dimensional view of a molded prism 100 according to the 1st example of the present disclosure. FIG. 1B is a partial enlarged view of the molded prism 100 according to the 1st example in FIG. 1A. FIG. 1C is a top view of the molded prism 100 according to the 1st example in FIG. 1A. FIG. 1D is a partial enlarged view of the molded prism 100 according to the 1st example in FIG. 1C. In FIGS. 1A to 1D, the molded prism 100 includes an optical body 110 and a sheet shading element 120, wherein the optical body 110 has a light path L passing through the optical body 110, and the sheet shading element 120 is covered via the optical body 110. In detail, the optical body 110 is made of plastic material, so that the optical body 110 can further obtain the function of absorbing and filtering the light with the specific wavelength, and the sheet shading element 120 can be made of metal material.

FIG. 1E is a side view of the molded prism 100 according to the 1st example in FIG. 1A. FIG. 1F is a cross-sectional view of the molded prism 100 according to the 1st example in FIG. 1E. In FIGS. 1A, 1C, 1E and 1F, the optical body 110 includes a gate trace 111 and reflecting surfaces 112, wherein the light path L is folded on the reflecting surfaces 112, and the light path L does not pass through the gate trace 111. In particular, the gate trace 111 is the trace of the injection channel of the optical body 110.

FIG. 1G is a partial enlarged view of the molded prism 100 according to the 1st example in FIG. 1F. In FIGS. 1B to 1D and 1G, the sheet shading element 120 is closer to the light path L than the gate trace 111 to the light path L, and the sheet shading element 120 includes a first surface 121, a second surface 122 and a first light blocking structure 123, wherein the second surface 122 is relative to the first surface 121, and the second surface 122 is farther away from the reflecting surfaces 112 than the first surface 121 from the reflecting surfaces 112. The first light blocking structure 123 includes a first periphery 141, wherein the first periphery 141 is connected to the first surface 121 and the second surface 122, the first periphery 141 faces towards the light path L, the first periphery 141 surrounds the light path L, and the optical body 110 is physically contacted with the first periphery 141, the first surface 121 and the second surface 122. By the sheet shading element 120 being closer to the light path L than the gate trace 111 to the light path L, the flare, which is formed owing to the light via the gate trace 111, can be avoided, so that the optical quality can be ensured. Further, the internal light blocking structure is formed by the optical body 110 being physically contacted with the first periphery 141, and the internal light blocking structure is simultaneously and physically contacted with the first surface 121 and the second surface 122, so that the combination of the sheet shading element 120 and the optical body 110 can be ensured.

Moreover, the first periphery 141 of the first light blocking structure 123 is closed and surrounds the light path L, and the aforementioned structure of the sheet shading element 120 can be further formed by the manufacturing process, such as the sheet metal process, the stamping process, the laser process and the etching process, but the present disclosure is not limited thereto.

In FIGS. 1A, 1B and 1G, the first periphery 141 includes a plurality of light blocking petals 142, and the light blocking petals 142 are adjacent arranged, wherein each of the light blocking petals 142 of the first periphery 141 includes a tapered portion 143 tapering towards a direction close to the light path L, and the light blocking petals 142 are covered inside the optical body 110. Therefore, the vignetting of the first periphery 141 can be smooth transited via the tapered portion 143 so as to enhance the imaging quality. According to the 1st example, a number of the light blocking petals 142 is 194. Via the light blocking petals 142, the effectiveness of the first light blocking structure 123 can be ensured. Furthermore, a thickness of each of the light blocking petals 142 gradually increases towards a direction away from the light path L. Therefore, the moldability can be ensured.

In FIGS. 1B and 1D, the tapered portion 143 of each of the light blocking petals 142 is tapered towards the direction close to the light path L to form a rear portion 144. Therefore, the peripheral quality can be further enhanced. Moreover, the rear portion 144 can be a tip, an arc or a plane, but the present disclosure is not limited thereto.

In FIGS. 1A and 1C, the sheet shading element 120 can further include a cutting mark 124 farther away from the light path L than the first periphery 141 from the light path L, and the cutting mark 124 exposes on the optical body 110.

Therefore, the stability of the sheet shading element 120 during the manufacturing process can be enhanced.

In FIG. 1F, the optical body 110 can further include an incident surface (its reference numeral is omitted) and an exit surface (its reference numeral is omitted), wherein the light path L passes through the incident surface, the reflecting surfaces 112 and the exit surface in sequence, and the sheet shading element 120 extends along directions away from the incident surface and the exit surface. Therefore, the forming quality of the optical surface and the shifting amount of the first light blocking structure 123 can be simultaneously considered by cooperating the extending direction of the sheet shading element 120 with the optical surface, so that the optical quality can be enhanced and ensured. Further, the optical quality can be improved by cooperating the release direction with optical surface. According to the 1st example, the incident surface and the exit surface are coplanar, and the incident surface and the exit surface can further obtain the reflecting function by the optical design of the total-reflection.

Moreover, the aforementioned direction is perpendicular to the incident surface and the exit surface so as to simplify the design and improve the efficiency of the quality control. Further, the light path L is folded at least twice occurring in the optical body 110. Therefore, the spatial utilization of an electronic device used a camera module with the molded prism 100 can be enhanced.

In FIGS. 1E and 1G, the optical body 110 can further include a release structure 115 disposed on a side of the sheet shading element 120 away from the first periphery 141, the release structure 115 is tapered along an extending direction of the sheet shading element 120, and at least one portion of the sheet shading element 120 is disposed on the release structure 115. By the design of disposing the sheet shading element 120 on the release structure 115, the manufacturing stability can be enhanced, and the shifting of the sheet shading element 120 can be reduced, so that the yield rate can be enhanced.

Furthermore, the sheet shading element 120 can be fixed in the specific position during the embedded injection process by the release structure 115, so that the shifting of the sheet shading element 120 can be reduced to further ensure the optical quality. In detail, the release structure 115 is tapered along the directions perpendicular to the incident surface and the exit surface to further cooperate the release direction with the optical surface, so that the optical quality can be enhanced.

In FIGS. 1A, 1B, 1C, 1E and 1G, the optical body 110 can further include a ridge structure 116, wherein the ridge structure 116 can include a plurality of recesses 161 arranged along a direction surrounding the light path L, each of the recesses 161 includes a recess end 162, the recess end 162 is corresponding to the first periphery 141 of the first light blocking structure 123, and each of the recesses 161 is gradually widened from the recess end 162 towards a direction away from the light path L. Therefore, the better optical quality can be achieved by cooperating the first periphery 141 with the multiple times of the light blocking.

In FIG. 1G, the optical body 110 can further include an anti-reflecting surface 117, wherein the light path L passes through the anti-reflecting surface 117. Therefore, the transmittance can be enhanced via the anti-reflecting surface 117 so as to improve the optical quality. Furthermore, the surface reflectivity of the anti-reflecting surface 117 can be reduced by disposing an anti-reflecting layer and a microstructure layer, but the present disclosure is not limited thereto.

FIG. 1H is another partial enlarged view of the molded prism 100 according to the 1st example in FIG. 1F. In FIGS. 1G and 1H, the release structure 115 can include a first release surface 151, a second release surface 152, a third release surface 153 and a fourth release surface 154, wherein the first release surface 151 is gradually close to the sheet shading element 120 along the extending direction of the sheet shading element 120, the second release surface 152 is relative to the first release surface 151, the third release surface 153 is relative to the fourth release surface 154, and the sheet shading element 120 is partially disposed between the first release surface 151 and the second release surface 152 and partially disposed between the third release surface 153 and the fourth release surface 154. Therefore, the effect of the release structure 115 can be further enhanced. Further, each of the release surfaces (that is, the first release surface 151, the second release surface 152, the third release surface 153 and the fourth release surface 154) can be a plane, an arc surface or a curved surface, but the present disclosure is not limited thereto.

In FIGS. 1B, 1C, 1E and 1G, the molded prism 100 can further include an opaque layer 170 and an exposed structure 180, wherein the opaque layer 170 is disposed on the ridge structure 116, the sheet shading element 120 is exposed on the exposed structure 180 to the optical body 110, and the release structure 115 is tapered on a direction away from the exposed structure 180. Therefore, the function of blocking the light of the ridge structure 116 can be further enhanced via the opaque layer 170 so as to improve the light blocking quality. Furthermore, the demolding process can be stable via the exposed structure 180 so as to avoid the molding defects. It should be mentioned that the cross pattern in FIGS. 1B, 1C and 1G is configured to indicate the range of the opaque layer 170.

Moreover, the sheet shading element 120 is exposed on the surface of the molded prism 100 at the exposed structure 180, so that the sheet shading element 120 can cooperate with the mold during forming. Therefore, the sheet shading element 120 can be fixed, and the sheet shading element 120 can be cooperated with another elements during disposing the molded prism 100 so as to enhance the light blocking quality. Simultaneously, the exposed structure 180 and the release structure 115 are disposed on relative sides, respectively, and the release structure 115 is tapered towards a direction away from the exposed structure 180. Therefore, the demolding process can be stable so as to avoid the forming defects.

In FIGS. 1A, 1C and 1E, the sheet shading element 120 can further include at least one bending portion 125 and a second light blocking structure 126, wherein at least one portion of the first periphery 141 is disposed on the bending portion 125, the second light blocking structure 126 includes a second periphery (its reference numeral is omitted), the second periphery faces towards the light path L, the second periphery surrounds the light path L, and the second periphery and the optical body 110 are physically contacted. The second periphery includes a plurality of light blocking petals 146, and the light blocking petals 146 are adjacently arranged, wherein each of the light blocking petals 146 of the second periphery includes a tapered portion 147 tapering towards a direction close to the light path L, and the light blocking petals 146 are covered inside of the optical body 110. According to the 1st example, a number of the light blocking petals 146 is 179. Via the bending portion 125, the mechanical property of the sheet shading element 120 can be enhanced so as to improve the manufacturing process, and the light from the different directions can be blocked. Further, by simultaneously providing multiple of the light blocking structures (that is, the first light blocking structure 123 and the second light blocking structure 126) via the sheet shading element 120, the elements can be reduced so as to lower the assembling cost.

An infrared light can be partially filtered via the molded prism 100. Therefore, the optical quality can be enhanced by filtering the light with the specific range of the wavelength. In detail, the aforementioned purpose of the molded prism 100 can be achieved by disposing the coating layer, disposing the optical body with the absorbing property of the infrared light or simultaneously multiple filtering methods.

FIG. 1I is a reflectance diagram of an anti-reflecting surface 117 according to the 1st example in FIG. 1A. FIG. 1J is a transmittance diagram of the molded prism 100 according to the 1st example in FIG. 1A. FIG. 1K is another transmittance diagram of the molded prism 100 according to the 1st example in FIG. 1A. In FIGS. 1D and 1G to 1K, when a distance between adjacent two of the rear portions 144 is D1; a distance between adjacent two of the recess ends 162 is D2; a thickness of the sheet shading element 120 is defined via a distance between the first surface 121 and the second surface 122, and the thickness of the sheet shading element 120 is T; a minimum distance between the first release surface 151 and the sheet shading element 120 is G1; a minimum distance between the first release surface 151 and the second release surface 152 is G12; a minimum distance between the third release surface 153 and the sheet shading element 120 is G3; a minimum distance between the third release surface 153 and the fourth release surface 154 is G34; a wavelength providing a transmittance of the molded prism 100 being 50% is T50, the following conditions of Table 1 are satisfied. It should be mentioned that all of the anti-reflecting surfaces 117 of the samples 1 to 9 in FIG. 1I can be applied to the 1st example.

TABLE 1
1st example

| | | | |
|---|---|---|---|
| D1 (mm) | 0.096 | G3 (mm) | 0.1 |
| D2 (mm) | 0.2 | G34 (mm) | 0.4 |
| T (mm) | 0.1 | T/G34 | 0.25 |
| G1 (mm) | 0.1 | T50 (nm) | 680 |
| | | (FIG. 1J) | |
| G12 (mm) | 0.3 | T50 (nm) | 610 |
| | | FIG. 1K) | |
| T/G12 | 0.33 | | |

It should be mentioned that the partial structures and elements are omitted in the partial drawings for clearly indicating the relationship between the optical body 110 and the sheet shading element 120.

### 2nd Example

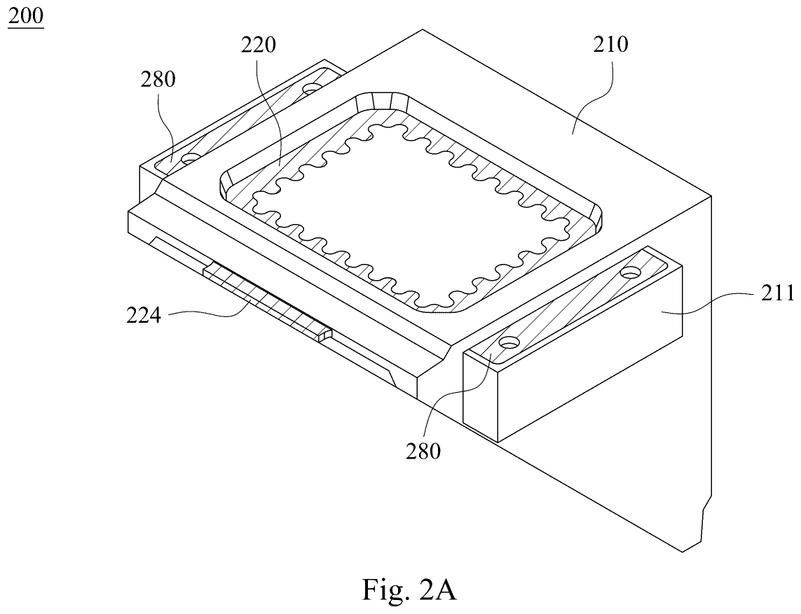

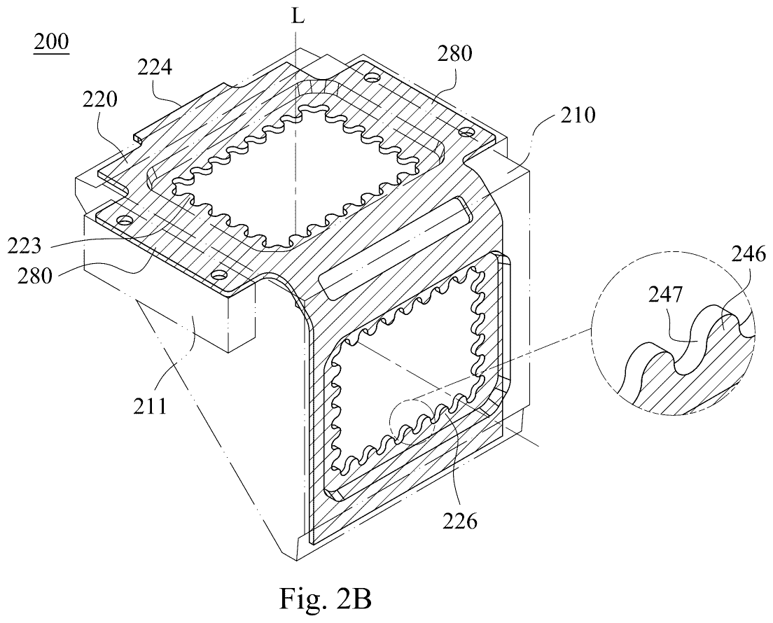

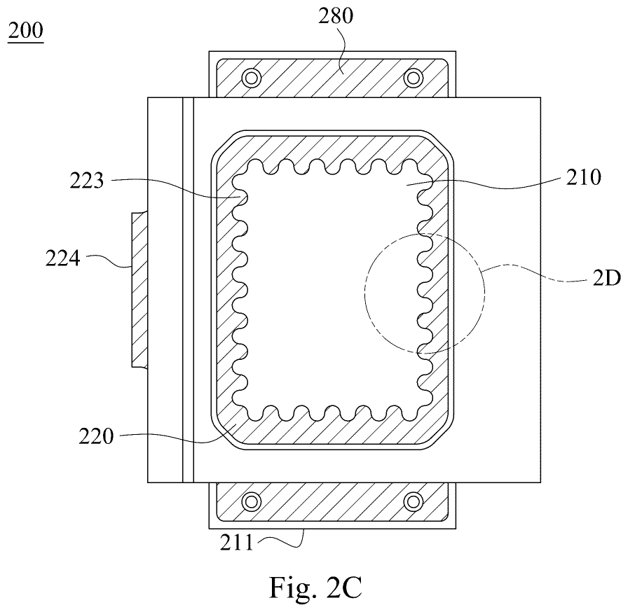

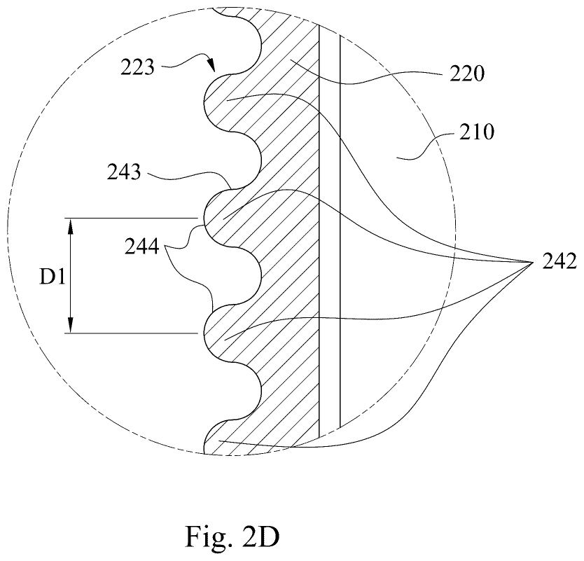

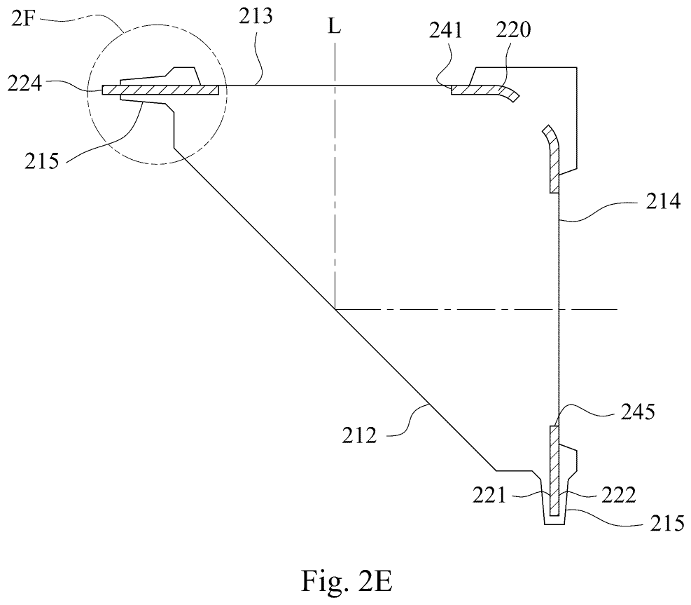

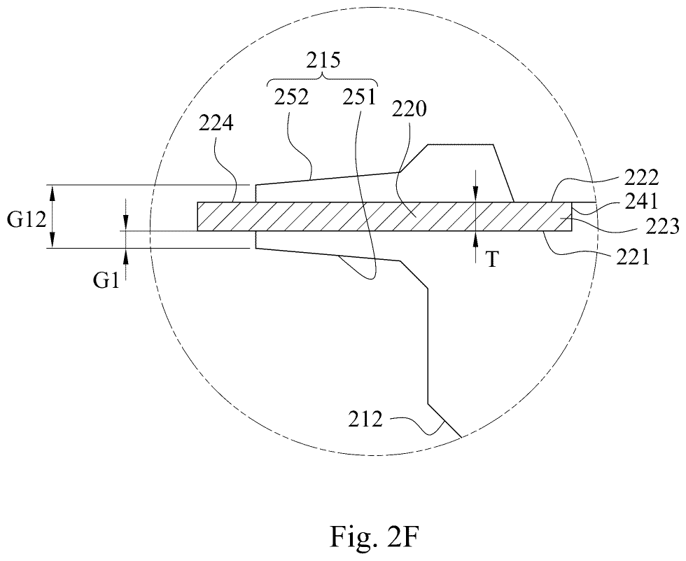

FIG. 2A is a three-dimensional view of a molded prism 200 according to the 2nd example of the present disclosure. FIG. 2B is a schematic view of the molded prism 200 according to the 2nd example in FIG. 2A. FIG. 2C is a top view of the molded prism 200 according to the 2nd example in FIG. 2A. FIG. 2D is a partial enlarged view of the molded prism 200 according to the 2nd example in FIG. 2C. In FIGS. 2A to 2D, the molded prism 200 includes an optical body 210 and a sheet shading element 220, wherein the optical body 210 has a light path L passing through the optical body 210, and the sheet shading element 220 is covered via the optical body 210.

FIG. 2E is a cross-sectional view of the molded prism 200 according to the 2nd example in FIG. 2A. In FIGS. 2A to 2C and 2E, the optical body 210 includes a gate trace 211 and a reflecting surface 212, wherein the light path L is folded on the reflecting surface 212, and the light path L does not pass through the gate trace 211.

In FIGS. 2B to 2E, the sheet shading element 220 is closer to the light path L than the gate trace 211 to the light path L, and the sheet shading element 220 includes a first surface 221, a second surface 222 and a first light blocking structure 223, wherein the second surface 222 is relative to the first surface 221, and the second surface 222 is farther away from the reflecting surface 212 than the first surface 221 from the reflecting surface 212. The first light blocking structure 223 includes a first periphery 241, wherein the first periphery 241 is connected to the first surface 221 and the second surface 222, the first periphery 241 faces towards the light path L, the first periphery 241 surrounds the light path L, and the optical body 210 is physically contacted with the first periphery 241, the first surface 221 and the second surface 222.

In FIGS. 2B and 2D, the first periphery 241 includes a plurality of light blocking petals 242, and the light blocking petals 242 are adjacent arranged, wherein each of the light blocking petals 242 of the first periphery 241 includes a tapered portion 243 tapering towards a direction close to the light path L, the light blocking petals 242 are covered inside the optical body 210, and the tapered portion 243 of each of the light blocking petals 242 is tapered towards the direction close to the light path L to form a rear portion 244. According to the 2nd example, a number of the light blocking petals 242 is 28. Moreover, the first periphery 241 is embedded in the optical body 210, and the portion of the second surface 222 close to the first periphery 241 is exposed on the surface of the optical body 210.

FIG. 2F is a partial enlarged view of the molded prism 200 according to the 2nd example in FIG. 2E. In FIGS. 2A, 2B, 20, 2E and 2F, the sheet shading element 220 can further include a cutting mark 224 farther away from the light path L than the first periphery 241 from the light path L, and the cutting mark 224 exposes on the optical body 210.

In FIG. 2E, the optical body 210 can further include an incident surface 213 and an exit surface 214, wherein the light path L passes through the incident surface 213, the reflecting surface 212 and the exit surface 214 in sequence, and two ends of the sheet shading element 220 extend along directions away from the incident surface 213 and away from the exit surface 214, respectively. Furthermore, the aforementioned directions are perpendicular to the reflecting surface 212.

In FIGS. 2E and 2F, the optical body 210 can further include a release structure 215 disposed on a side of the sheet shading element 220 away from the first periphery 241, the release structure 215 is tapered along an extending direction of the sheet shading element 220, and at least one portion of the sheet shading element 220 is disposed on the release structure 215. In FIG. 2E, the release structure 215 at the upper left position is tapered along the direction perpendicular to the exit surface 214, and the release structure 215 at the lower right position is tapered along the direction perpendicular to the incident surface 213. Further, the cutting mark 224 can be further disposed on the release structure 215, so that the shifting of the sheet shading element 220 during the forming process can be reduced, but the present disclosure is not limited thereto.

In FIG. 2F, the release structure 215 can include a first release surface 251 and a second release surface 252, wherein the first release surface 251 is gradually close to the sheet shading element 220 along the extending direction of the sheet shading element 220, the second release surface 252 is relative to the first release surface 251, and the sheet shading element 220 is disposed between the first release surface 251 and the second release surface 252.

In FIGS. 2A to 2C, the molded prism 200 can further include an exposed structure 280, wherein the sheet shading element 220 is exposed on the exposed structure 280 to the optical body 210, and the release structure 215 is tapered on a direction away from the exposed structure 280.

In FIGS. 2B and 2E, the sheet shading element 220 can further include a second light blocking structure 226, wherein the second light blocking structure 226 includes a second periphery 245, the second periphery 245 is connected to the first surface 221 and the second surface 222, the second periphery 245 faces towards the light path L, the second periphery 245 surrounds the light path L, and the second periphery 245 is physically contacted with the optical body 210. The second periphery 245 includes a plurality of light blocking petals 246, and the light blocking petals 246 are adjacently arranged, wherein each of the light blocking petals 246 of the second periphery 245 includes a tapered portion 247 tapering towards a direction close to the light path L, and the light blocking petals 246 are covered inside of the optical body 210. According to the 2nd example, a number of the light blocking petals 246 is 28.

In FIGS. 2D and 2F, when a distance between adjacent two of the rear portions 244 is D1; a thickness of the sheet shading element 220 is defined via a distance between the first surface 221 and the second surface 222, and the thickness of the sheet shading element 220 is T; a minimum distance between the first release surface 251 and the sheet shading element 220 is G1; a minimum distance between the first release surface 251 and the second release surface 252 is G12, the following conditions of Table 2 are satisfied.

TABLE 2
2nd example

| | | | |
|---|---|---|---|
| D1 (mm) | 0.4 | T (mm) | 0.1 |
| G1 (mm) | 0.06 | T/G12 | 0.454 |
| G12 (mm) | 0.22 | | |

It should be mentioned that the partial structures and elements are omitted in the partial drawings for clearly indicating the relationship between the optical body 210 and the sheet shading element 220.

### 3rd Example

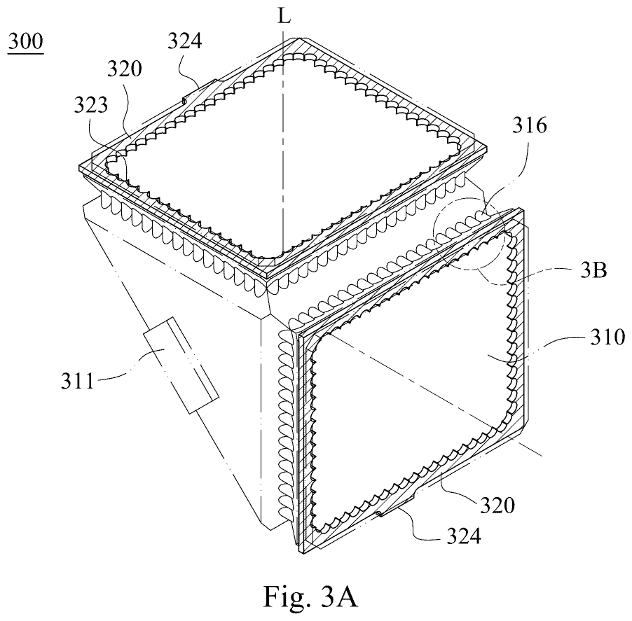

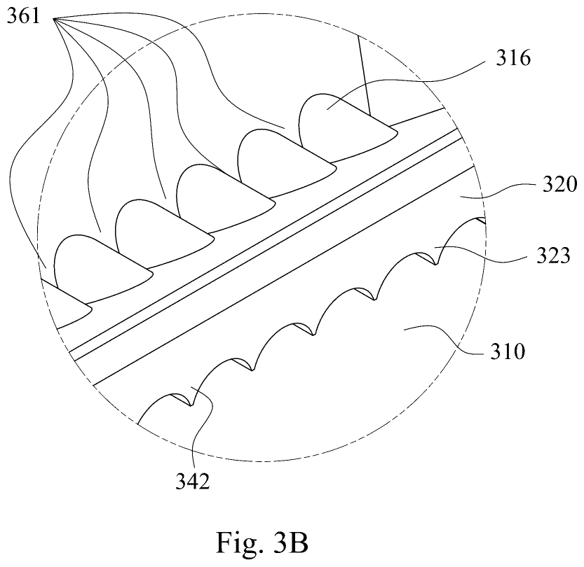

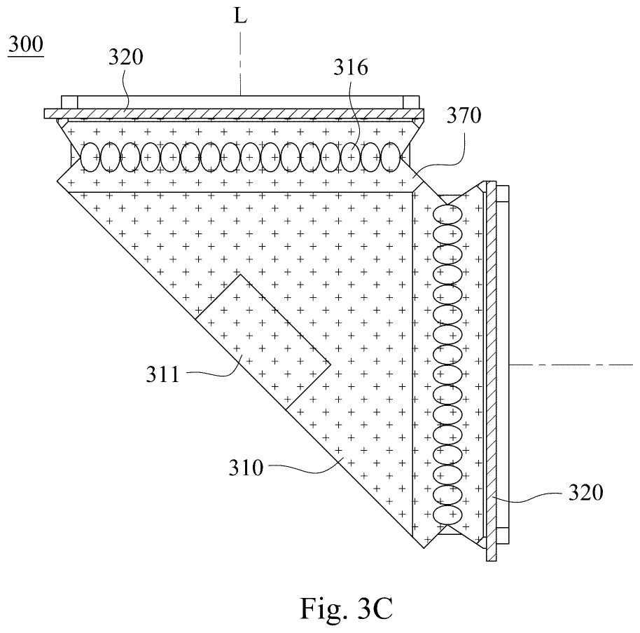

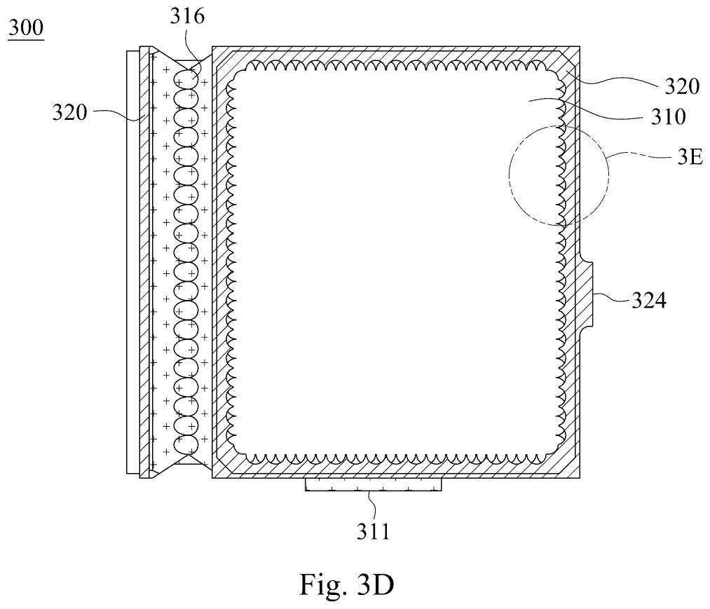

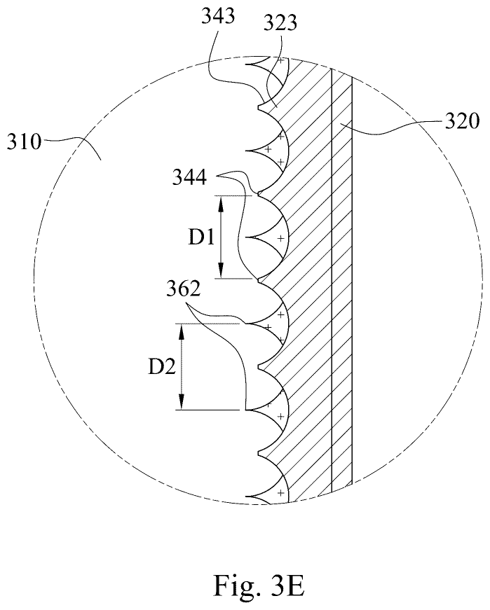

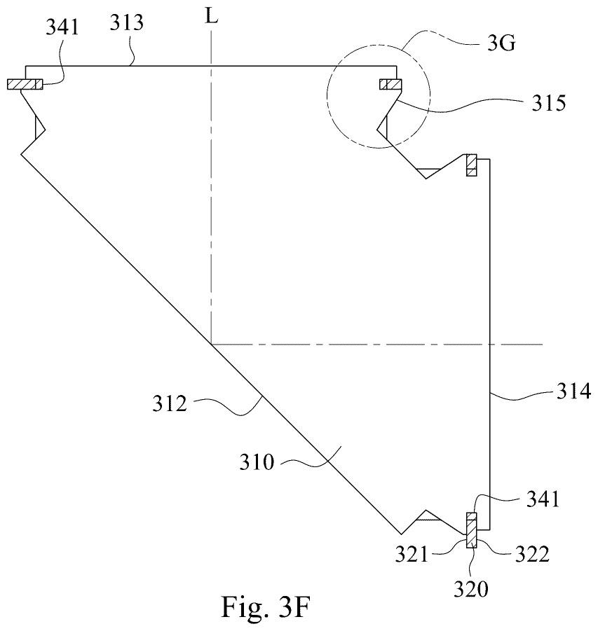

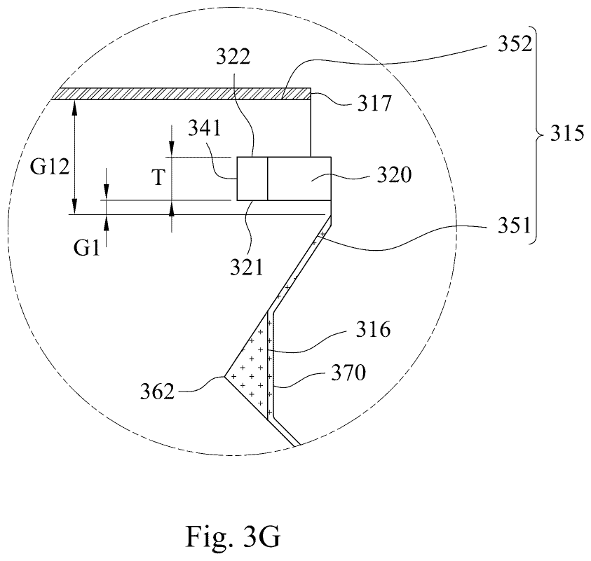

FIG. 3A is a three-dimensional view of a molded prism 300 according to the 3rd example of the present disclosure. FIG. 3B is a partial enlarged view of the molded prism 300 according to the 3rd example in FIG. 3A. FIG. 3C is a side view of the molded prism 300 according to the 3rd example in FIG. 3A. FIG. 3D is a top view of the molded prism 300 according to the 3rd example in FIG. 3A. FIG. 3E is a partial enlarged view of the molded prism 300 according to the 3rd example in FIG. 3D. In FIGS. 3A to 3E, the molded prism 300 includes an optical body 310 and a sheet shading element 320, wherein the optical body 310 has a light path L passing through the optical body 310, and the sheet shading element 320 is covered via the optical body 310. According to the 3rd example, a number of the sheet shading element 320 is two. Therefore, the degree of freedom of the light blocking type of the prism can be enhanced so as to satisfy the optical requirements.

FIG. 3F is a cross-sectional view of the molded prism 300 according to the 3rd example in FIG. 3A. In FIGS. 3A, 3C and 3F, the optical body 310 includes a gate trace 311 and a reflecting surface 312, wherein the light path L is folded on the reflecting surface 312, and the light path L does not pass through the gate trace 311.

FIG. 3G is a partial enlarged view of the molded prism 300 according to the 3rd example in FIG. 3F. In FIGS. 3A, 3B and 3E to 3G, the sheet shading element 320 is closer to the light path L than the gate trace 311 to the light path L, and the sheet shading element 320 includes a first surface 321, a second surface 322 and a first light blocking structure 323, wherein the second surface 322 is relative to the first surface 321, and the second surface 322 is farther away from the reflecting surface 312 than the first surface 321 from the reflecting surface 312. The first light blocking structure 323 includes a first periphery 341, wherein the first periphery 341 is connected to the first surface 321 and the second surface 322, the first periphery 341 faces towards the light path L, the first periphery 341 surrounds the light path L, and the optical body 310 is physically contacted with the first periphery 341, the first surface 321 and the second surface 322.

In FIGS. 3B and 3E, the first periphery 341 includes a plurality of light blocking petals 342, and the light blocking petals 342 are adjacent arranged, wherein each of the light blocking petals 342 of the first periphery 341 includes a tapered portion 343 tapering towards a direction close to the light path L, the light blocking petals 342 are covered inside the optical body 310, and the tapered portion 343 of each of the light blocking petals 342 is tapered towards the direction close to the light path L to form a rear portion 344. According to the 3rd example, a number of the light blocking petals 342 is 72.

In FIGS. 3A and 3D, the sheet shading element 320 can further include a cutting mark 324 farther away from the light path L than the first periphery 341 from the light path L, and the cutting mark 324 exposes on the optical body 310.

In FIG. 3F, the optical body 310 can further include an incident surface 313 and an exit surface 314, wherein the light path L passes through the incident surface 313, the reflecting surface 312 and the exit surface 314 in sequence, and the two sheet shading elements 320 extend along directions away from the incident surface 313 and from the exit surface 314, respectively. Furthermore, the aforementioned directions are perpendicular to the incident surface 313 and the exit surface 314.

In FIGS. 3A to 3G, the optical body 310 can further include a release structure 315, a ridge structure 316 and an anti-reflecting surface 317, wherein the light path L passes through the anti-reflecting surface 317. The release structure 315 is disposed on a side of the sheet shading element 320 away from the first periphery 341, the release structure 315 is tapered along an extending direction of the sheet shading element 320, and at least one portion of the sheet shading element 320 is disposed on the release structure 315, wherein the release structure 315 is tapered along a direction perpendicular to the reflecting surface 312. The ridge structure 316 includes a plurality of recesses 361 arranged along a direction surrounding the light path L, each of the recesses 361 includes a recess end 362, the recess end 362 is corresponding to the first periphery 341 of the first light blocking structure 323, and each of the recesses 361 is gradually widened from the recess end 362 towards a direction away from the light path L.

In FIG. 3G, the release structure 315 can include a first release surface 351 and a second release surface 352, wherein the first release surface 351 is gradually close to the sheet shading element 320 along the extending direction of the sheet shading element 320, the second release surface 352 is relative to the first release surface 351, and the sheet shading element 320 is disposed between the first release surface 351 and the second release surface 352.

In FIGS. 3C and 3G, the molded prism 300 can further include an opaque layer 370, wherein the opaque layer 370 is disposed on the ridge structure 316. It should be mentioned that the cross pattern in FIGS. 3C to 3E and 3G is configured to indicate the range of the opaque layer 370.

In FIGS. 3E and 3G, when a distance between adjacent two of the rear portions 344 is D1; a distance between adjacent two of the recess ends 362 is D2; a thickness of the sheet shading element 320 is defined via a distance between the first surface 321 and the second surface 322, and the thickness of the sheet shading element 320 is T; a minimum distance between the first release surface 351 and the sheet shading element 320 is G1; a minimum distance between the first release surface 351 and the second release surface 352 is G12, the following conditions of Table 3 are satisfied.

TABLE 3
3rd example

| | | | |
|---|---|---|---|
| D1 (mm) | 0.287 | G1 (mm) | 0.05 |
| D2 (mm) | 0.3 | G12 (mm) | 0.4 |
| T (mm) | 0.15 | T/G12 | 0.375 |

It should be mentioned that the partial structures and elements are omitted in the partial drawings for clearly indicating the relationship between the optical body 310 and the sheet shading element 320.

### 4th Example

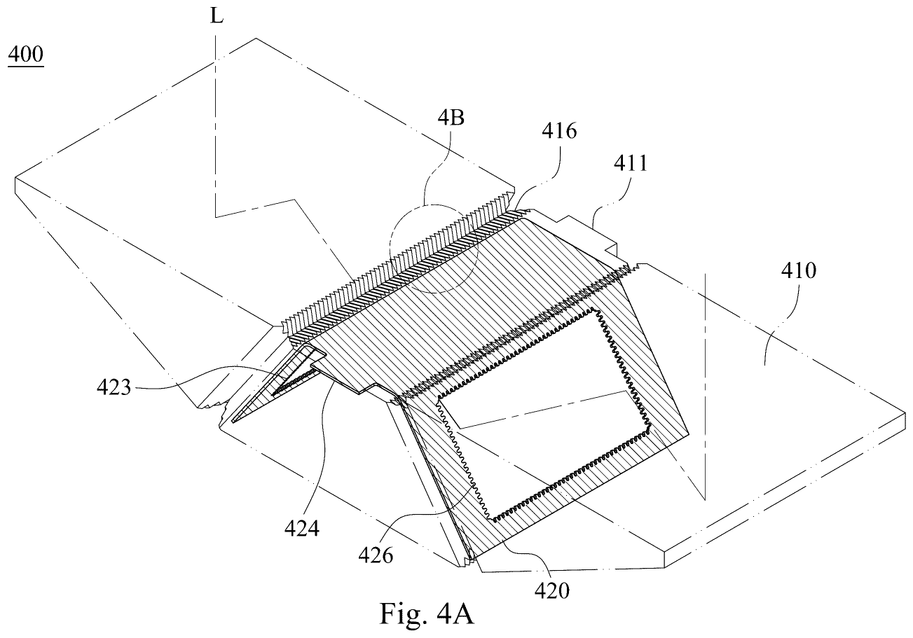

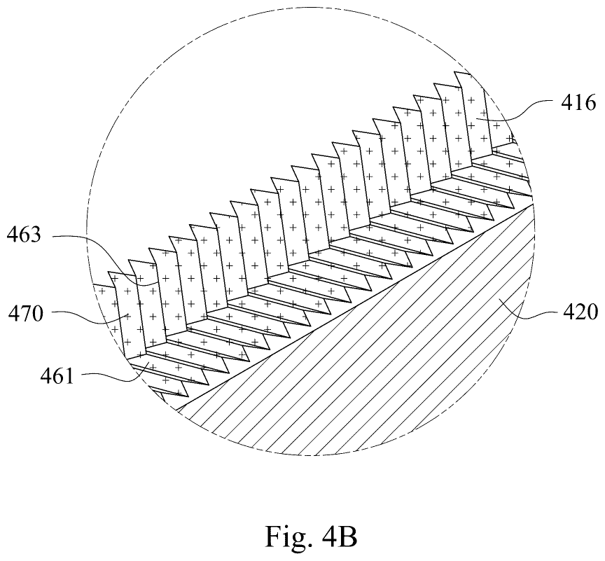

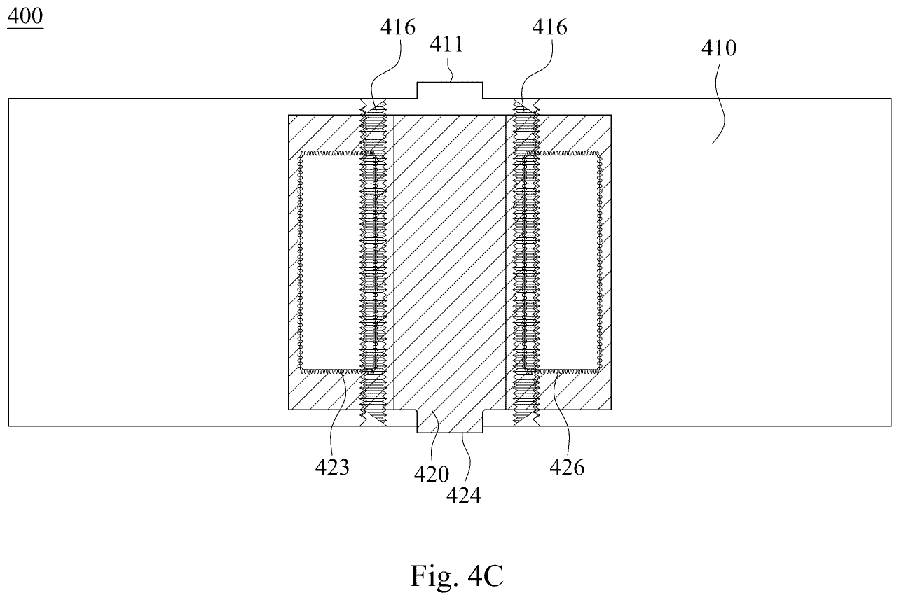

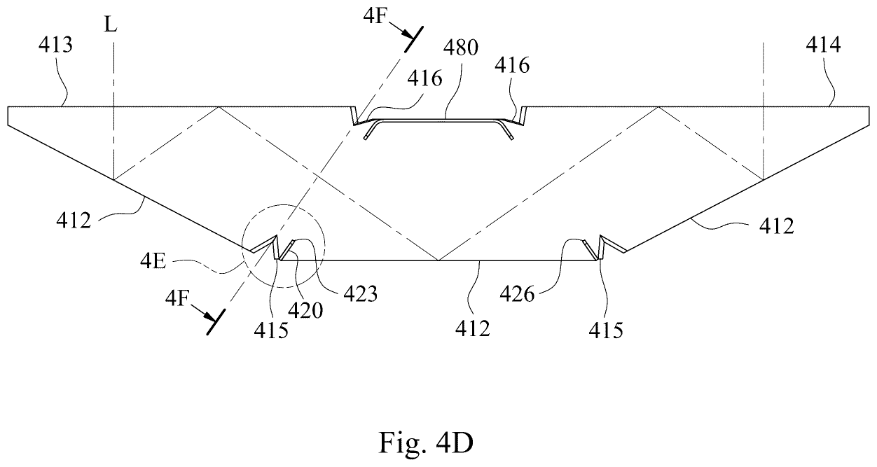

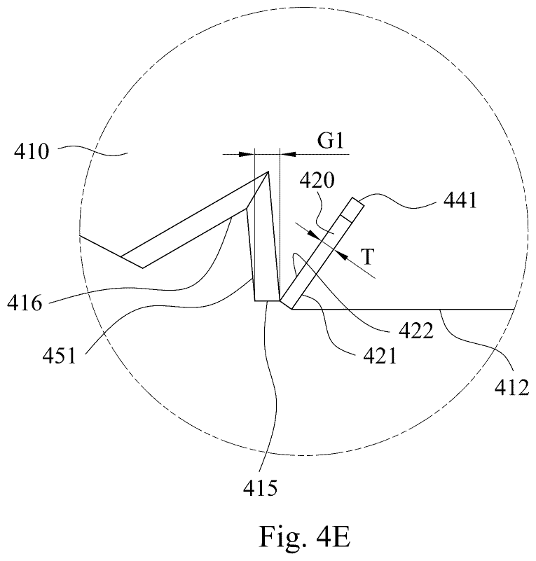

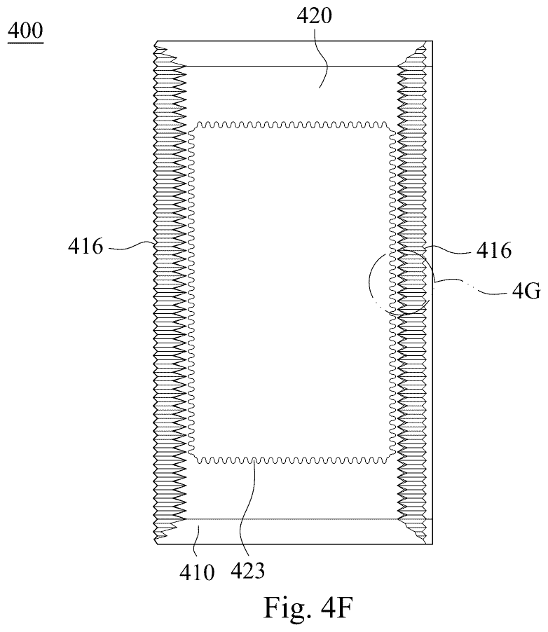

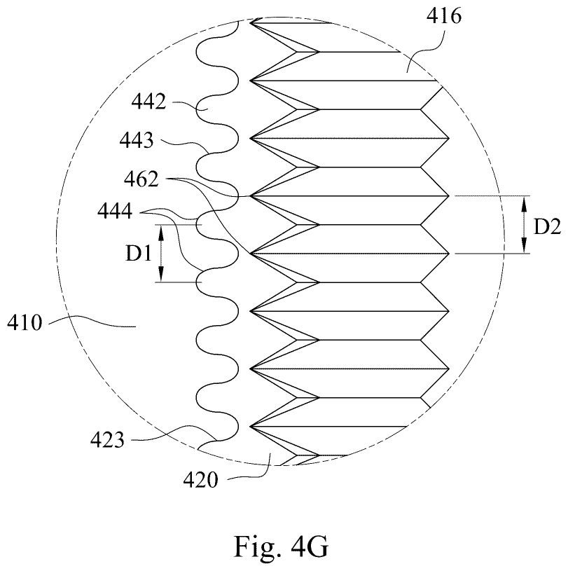

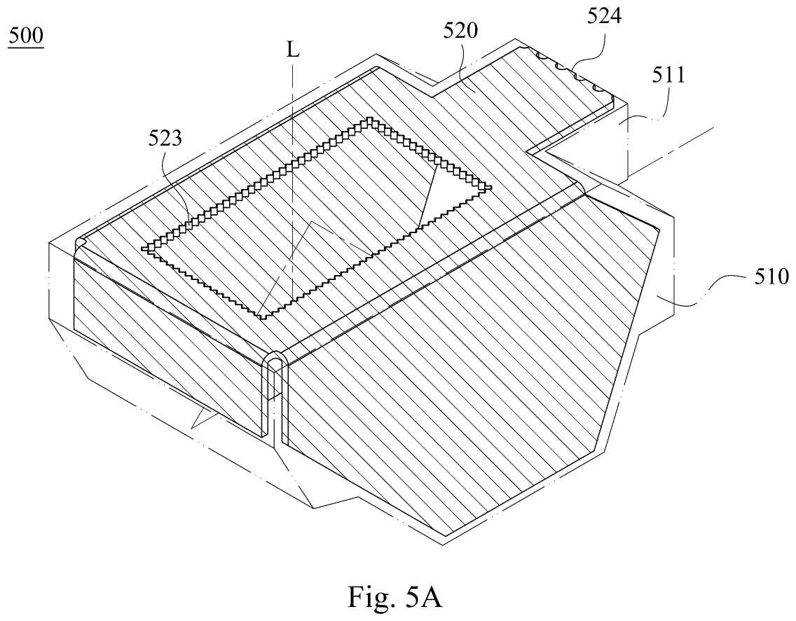

FIG. 4A is a three-dimensional view of a molded prism 400 according to the 4th example of the present disclosure. FIG. 4B is a partial enlarged view of the molded prism 400 according to the 4th example in FIG. 4A. FIG. 4C is a top view of the molded prism 400 according to the 4th example in FIG. 4A. In FIGS. 4A to 4C, the molded prism 400 includes an optical body 410 and a sheet shading element 420, wherein the optical body 410 has a light path L passing through the optical body 410, and the sheet shading element 420 is covered via the optical body 410.

FIG. 4D is a cross-sectional view of the molded prism 400 according to the 4th example in FIG. 4A. FIG. 4E is a partial enlarged view of the molded prism 400 according to the 4th example in FIG. 4D. In FIGS. 4A, 4D and 4E, the optical body 410 includes a gate trace 411 and a reflecting surface 412, wherein the light path L is folded on the reflecting surface 412, and the light path L does not pass through the gate trace 411.

FIG. 4F is a cross-sectional schematic view of the molded prism 400 along line 4F-4F in FIG. 4D. FIG. 4G is a partial enlarged view of the molded prism 400 according to the 4th example in FIG. 4F. In FIGS. 4A and 4C to 4G, the sheet shading element 420 is closer to the light path L than the gate trace 411 to the light path L, and the sheet shading element 420 includes a first surface 421, a second surface 422 and a first light blocking structure 423, wherein the second surface 422 is relative to the first surface 421, and the second surface 422 is farther away from the reflecting surface 412 than the first surface 421 from the reflecting surface 412. The first light blocking structure 423 includes a first periphery 441, wherein the first periphery 441 is connected to the first surface 421 and the second surface 422, the first periphery 441 faces towards the light path L, the first periphery 441 surrounds the light path L, and the optical body 410 is physically contacted with the first periphery 441, the first surface 421 and the second surface 422.

In FIG. 4G, the first periphery 441 includes a plurality of light blocking petals 442, and the light blocking petals 442 are adjacent arranged, wherein each of the light blocking petals 442 of the first periphery 441 includes a tapered portion 443 tapering towards a direction close to the light path L, the light blocking petals 442 are covered inside the optical body 410, and the tapered portion 443 of each of the light blocking petals 442 is tapered towards the direction close to the light path L to form a rear portion 444. According to the 4th example, a number of the light blocking petals 442 is 128.

In FIGS. 4A and 4C, the sheet shading element 420 can further include a cutting mark 424 farther away from the light path L than the first periphery 441 from the light path L, and the cutting mark 424 exposes on the optical body 410.

In FIG. 4D, the optical body 410 can further include an incident surface 413 and an exit surface 414, wherein the light path L passes through the incident surface 413, the reflecting surface 412 and the exit surface 414 in sequence, the sheet shading element 420 extends along directions away from the incident surface 413 and from the exit surface 414, and the light path L is folded at least twice occurring in the optical body 410. Furthermore, the aforementioned direction is perpendicular to the incident surface 413 and the exit surface 414.

In FIGS. 4A to 4G, the optical body 410 can further include a release structure 415, wherein the release structure 415 is disposed on a side of the sheet shading element 420 away from the first periphery 441, the release structure 415 is tapered along an extending direction of the sheet shading element 420, at least one portion of the sheet shading element 420 is disposed on the release structure 415, and the release structure 415 includes a ridge structure 416. The ridge structure 416 includes a plurality of recesses 461 arranged along a direction surrounding the light path L, each of the recesses 461 includes a recess end 462, the recess end 462 is corresponding to the first periphery 441 of the first light blocking structure 423, and each of the recesses 461 is gradually widened from the recess end 462 towards a direction away from the light path L.

In FIG. 4B, the ridge structure 416 can further include a plurality of ribs 463 extending from the recesses 461 towards a direction away from the light path L. Therefore, the anti-reflecting ability of the optical body 410 can be further enhanced.

In FIG. 4E, the release structure 415 can further include a first release surface 451, wherein the first release surface 451 is gradually close to the sheet shading element 420 along the extending direction of the sheet shading element 420.

In FIGS. 4B and 4D, the molded prism 400 can further include an opaque layer 470 and an exposed structure 480, wherein the opaque layer 470 is disposed on the ridge structure 416, the sheet shading element 420 is exposed on the exposed structure 480 to the optical body 410, and the release structure 415 is tapered on a direction away from the exposed structure 480. It should be mentioned that the cross pattern in FIG. 4B is configured to indicate the range of the opaque layer 470.

In FIGS. 4A, 4C and 4D, the sheet shading element 420 can further include a second light blocking structure 426, wherein the second light blocking structure 426 includes a second periphery (its reference numeral is omitted), the second periphery is connected to the first surface 421 and the second surface 422, the second periphery faces towards the light path L, the second periphery surrounds the light path L, the second periphery is physically contacted with the optical body 410, and the first light blocking structure 423 and the second light blocking structure 426 surround the light path L, respectively. The second periphery includes a plurality of light blocking petals (its reference numeral is omitted), and the light blocking petals are adjacently arranged, wherein each of the light blocking petals of the second periphery includes a tapered portion (its reference numeral is omitted) tapering towards a direction close to the light path L, and the light blocking petals are covered inside of the optical body 410. According to the 4th example, the disposition of the first light blocking structure 423 and the disposition of the second light blocking structure 426 are the same, and will not be described again herein.

In FIGS. 4E and 4G, when a distance between adjacent two of the rear portions 444 is D1; a distance between adjacent two of the recess ends 462 is D2; a thickness of the sheet shading element 420 is defined via a distance between the first surface 421 and the second surface 422, and the thickness of the sheet shading element 420 is T; a minimum distance between the first release surface 451 and the sheet shading element 420 is G1, the following conditions of Table 4 are satisfied.

TABLE 4
4th example

| | | | |
|---|---|---|---|
| D1 (mm) | 0.1 | G1 (mm) | 0.0866 |
| D2 (mm) | 0.1 | T (mm) | 0.05 |

It should be mentioned that the partial structures and elements are omitted in the partial drawings for clearly indicating the relationship between the optical body 410 and the sheet shading element 420.

### 5th Example

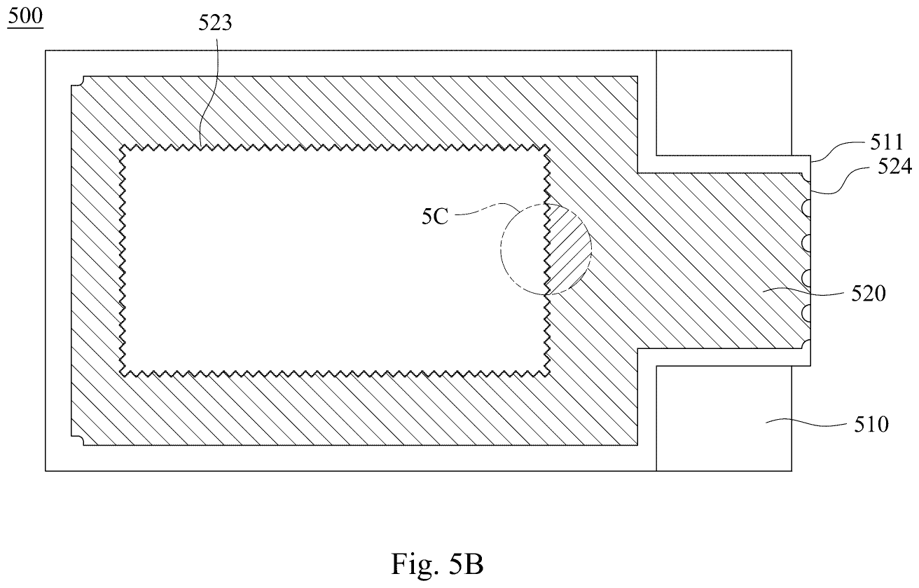

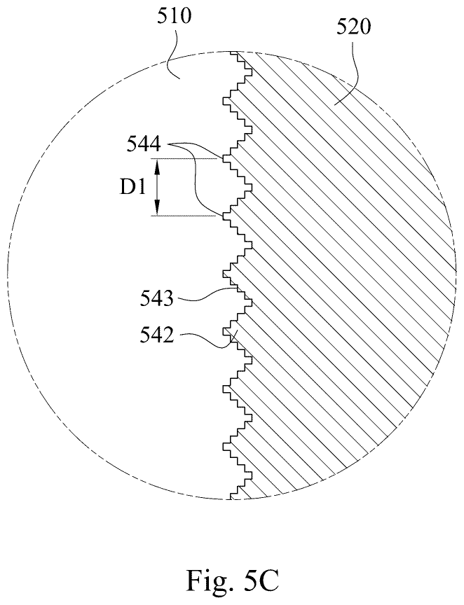

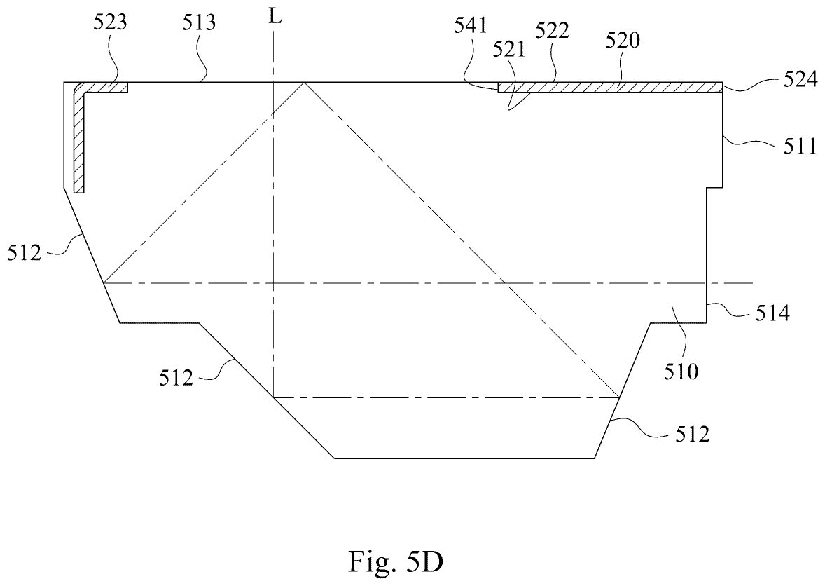

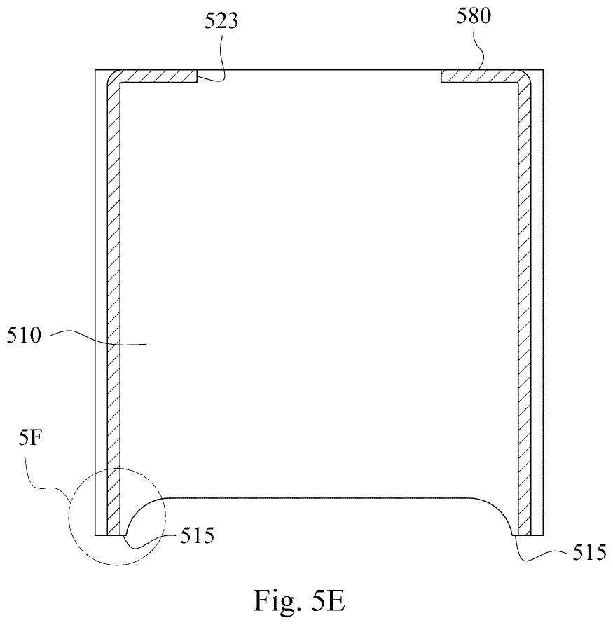

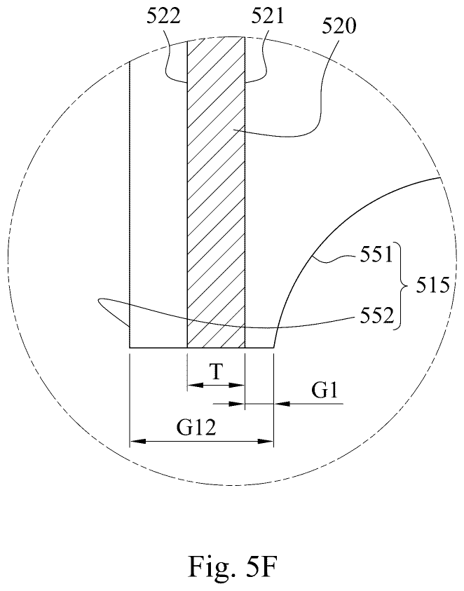

FIG. 5A is a three-dimensional view of a molded prism 500 according to the 5th example of the present disclosure. FIG. 5B is a top view of the molded prism 500 according to the 5th example in FIG. 5A. FIG. 5C is a partial enlarged view of the molded prism 500 according to the 5th example in FIG. 5B. In FIGS. 5A to 5C, the molded prism 500 includes an optical body 510 and a sheet shading element 520, wherein the optical body 510 has a light path L passing through the optical body 510, and the sheet shading element 520 is covered via the optical body 510.

FIG. 5D is a cross-sectional view of the molded prism 500 according to the 5th example in FIG. 5A. In FIGS. 5A, 5B and 5D, the optical body 510 includes a gate trace 511 and a reflecting surface 512, wherein the light path L is folded on the reflecting surface 512, and the light path L does not pass through the gate trace 511.

FIG. 5E is another cross-sectional view of the molded prism 500 according to the 5th example in FIG. 5A. FIG. 5F is a partial enlarged view of the molded prism 500 according to the 5th example in FIG. 5E. In FIGS. 5A, 5B and 5D to 5F, the sheet shading element 520 is closer to the light path L than the gate trace 511 to the light path L, and the sheet shading element 520 includes a first surface 521, a second surface 522 and a first light blocking structure 523, wherein the second surface 522 is relative to the first surface 521, and the second surface 522 is farther away from the reflecting surface 512 than the first surface 521 from the reflecting surface 512. The first light blocking structure 523 includes a first periphery 541, wherein the first periphery 541 is connected to the first surface 521 and the second surface 522, the first periphery 541 faces towards the light path L, the first periphery 541 surrounds the light path L, and the optical body 510 is physically contacted with the first periphery 541, the first surface 521 and the second surface 522.

In FIG. 5C, the first periphery 541 includes a plurality of light blocking petals 542, and the light blocking petals 542 are adjacently arranged, wherein each of the light blocking petals 542 of the first periphery 541 includes a tapered portion 543 tapering towards a direction close to the light path L, the light blocking petals 542 are covered inside the optical body 510, and the tapered portion 543 of each of the light blocking petals 542 is tapered towards the direction close to the light path L to form a rear portion 544. According to the 5th example, a number of the light blocking petals 542 is 110.

In FIGS. 5A, 5B and 5D, the sheet shading element 520 can further include a cutting mark 524 farther away from the light path L than the first periphery 541 from the light path L, and the cutting mark 524 exposes on the optical body 510. Furthermore, the cutting mark 524 can further be physically contacted with the gate trace 511, and the sheet shading element 520 and the optical body 510 can be finished cutting once so as to enhance the manufacturing efficiency.

In FIG. 5D, the optical body 510 can further include an incident surface 513 and an exit surface 514, wherein the light path L passes through the incident surface 513, the reflecting surface 512 and the exit surface 514 in sequence, the sheet shading element 520 extends along a direction away from the exit surface 514, and the light path L is folded at least twice occurring in the optical body 510. Furthermore, the aforementioned direction is perpendicular to the reflecting surface 512.

In FIGS. 5E and 5F, the optical body 510 can further include a release structure 515, wherein the release structure 515 is disposed on a side of the sheet shading element 520 away from the first periphery 541, the release structure 515 is tapered along an extending direction of the sheet shading element 520, and at least one portion of the sheet shading element 520 is disposed on the release structure 515.

In FIG. 5F, the release structure 515 can include a first release surface 551 and a second release surface 552, wherein the first release surface 551 is gradually close to the sheet shading element 520 along the extending direction of the sheet shading element 520, the second release surface 552 is relative to the first release surface 551, and the sheet shading element 520 is disposed between the first release surface 551 and the second release surface 552.

In FIG. 5E, the molded prism 500 can further include an exposed structure 580, wherein the sheet shading element 520 is exposed on the exposed structure 580 to the optical body 510, and the release structure 515 is tapered on a direction away from the exposed structure 580.

In FIGS. 5A, 5B and 5D, the first periphery 541 of the first light blocking structure 523 is closed and surrounds the light path L.

In FIGS. 5C and 5F, when a distance between adjacent two of the rear portions 544 is D1; a thickness of the sheet shading element 520 is defined via a distance between the first surface 521 and the second surface 522, and the thickness of the sheet shading element 520 is T; a minimum distance between the first release surface 551 and the sheet shading element 520 is G1; a minimum distance between the first release surface 551 and the second release surface 552 is G12, the following conditions of Table 5 are satisfied.

TABLE 5
5th example

| | | | |
|---|---|---|---|
| D1 (mm) | 0.175 | T (mm) | 0.2 |
| G1 (mm) | 0.1 | T/G12 | 0.4 |
| G12 (mm) | 0.5 | | |

It should be mentioned that the partial structures and elements are omitted in the partial drawings for clearly indicating the relationship between the optical body 510 and the sheet shading element 520.

### 6th Example

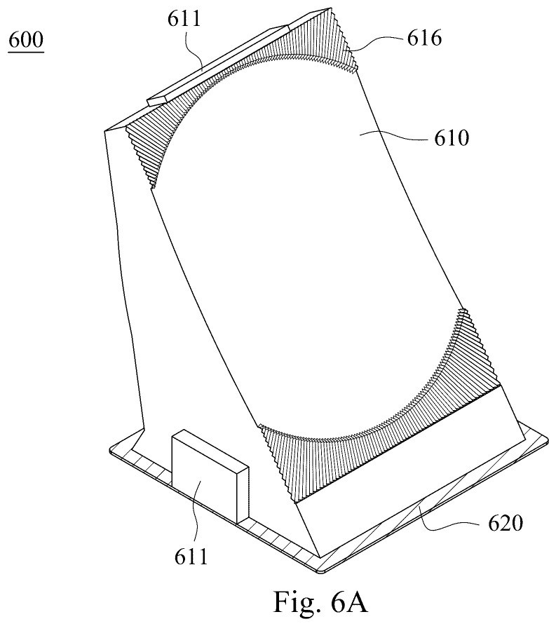

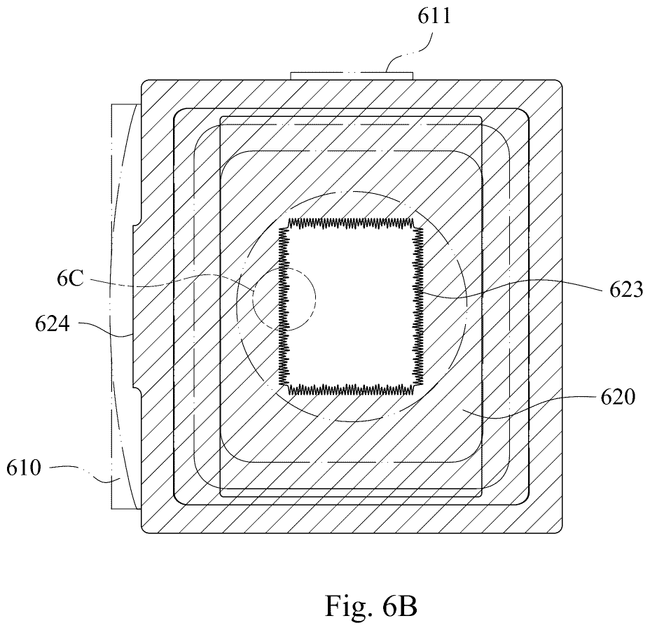

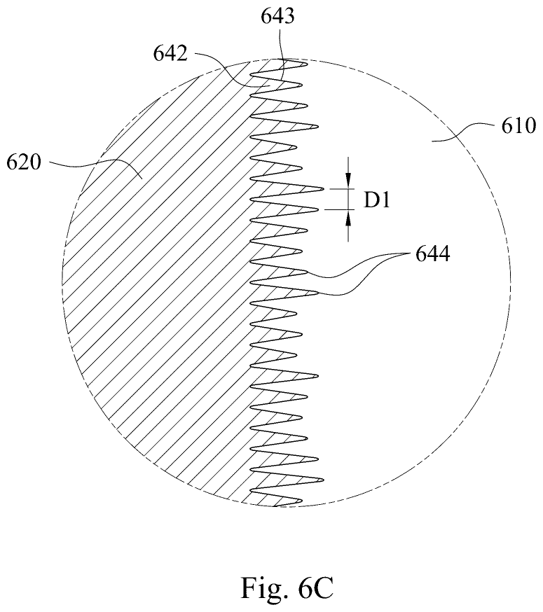

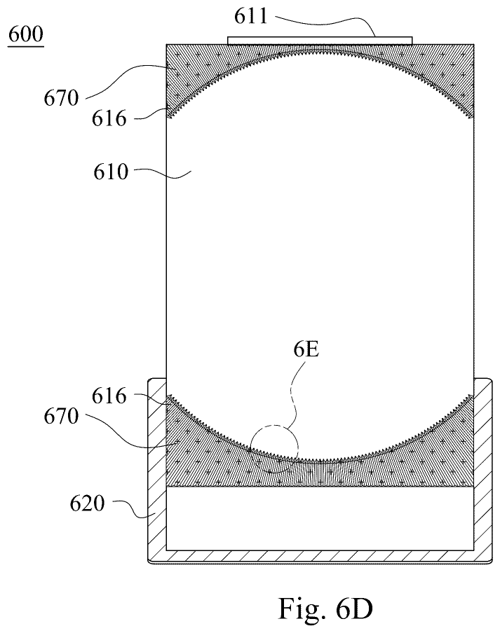

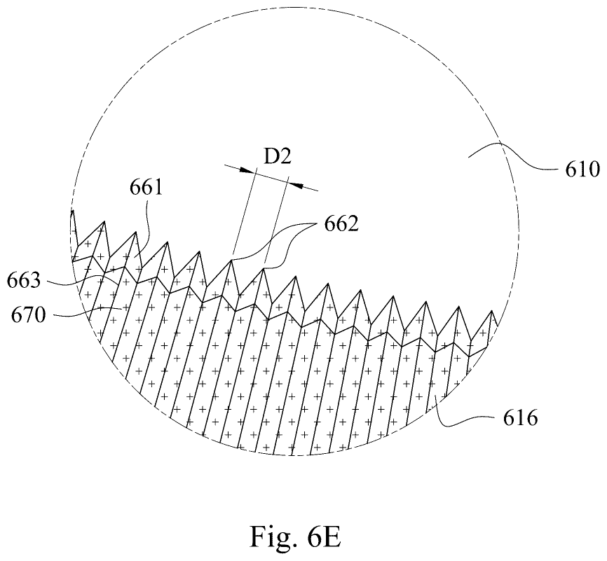

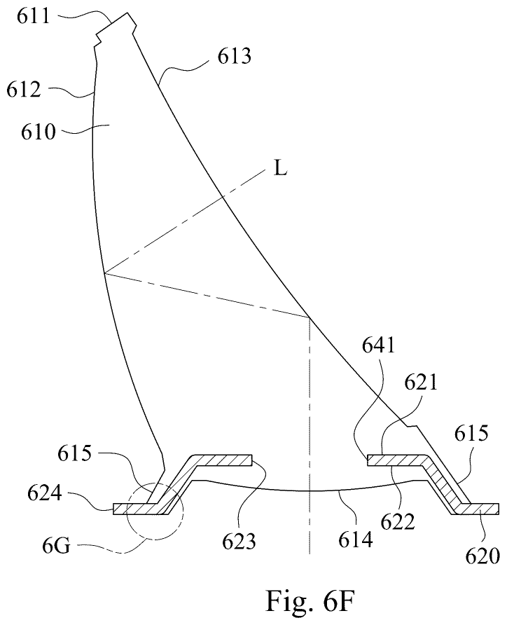

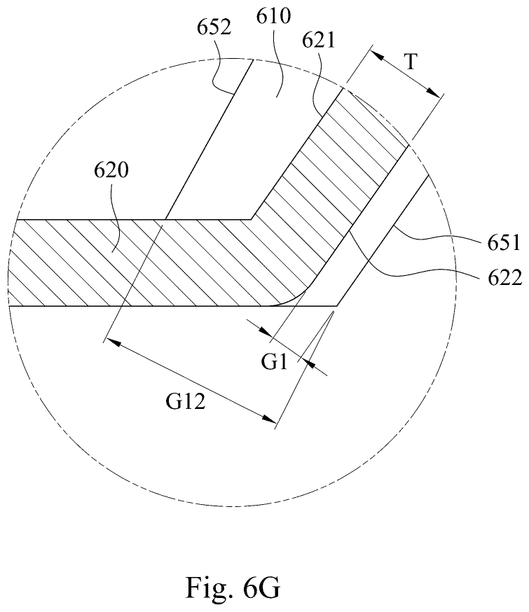

FIG. 6A is a three-dimensional view of a molded prism 600 according to the 6th example of the present disclosure, FIG. 6B is a side view of the molded prism 600 according to the 6th example in FIG. 6A, FIG. 6C is a partial enlarged view of the molded prism 600 according to the 6th example in FIG. 6B, FIG. 6D is another side view of the molded prism 600 according to the 6th example in FIG. 6A, and FIG. 6E is a partial enlarged view of the molded prism 600 according to the 6th example in FIG. 6D. In FIGS. 6A to 6E, the molded prism 600 includes an optical body 610 and a sheet shading element 620, wherein the optical body 610 has a light path L passing through the optical body 610, and the sheet shading element 620 is covered via the optical body 610.

FIG. 6F is a cross-sectional view of the molded prism 600 according to the 6th example in FIG. 6A. In FIGS. 6A, 6B, 6D and 6F, the optical body 610 includes a gate trace 611 and a reflecting surface 612, wherein the light path L is folded on the reflecting surface 612, and the light path L does not pass through the gate trace 611.

FIG. 6G is a partial enlarged view of the molded prism 600 according to the 6th example in FIG. 6F. In FIGS. 6B, 6F and 6G, the sheet shading element 620 is closer to the light path L than the gate trace 611 to the light path L, and the sheet shading element 620 includes a first surface 621, a second surface 622 and a first light blocking structure 623, wherein the second surface 622 is relative to the first surface 621, and the second surface 622 is farther away from the reflecting surface 612 than the first surface 621 from the reflecting surface 612. The first light blocking structure 623 includes a first periphery 641, wherein the first periphery 641 is connected to the first surface 621 and the second surface 622, the first periphery 641 faces towards the light path L, the first periphery 641 surrounds the light path L, and the optical body 610 is physically contacted with the first periphery 641, the first surface 621 and the second surface 622.

In FIG. 6C, the first periphery 641 includes a plurality of light blocking petals 642, and the light blocking petals 642 are adjacently arranged, wherein each of the light blocking petals 642 of the first periphery 641 includes a tapered portion 643 tapering towards a direction close to the light path L, the light blocking petals 642 are covered inside the optical body 610, and the tapered portion 643 of each of the light blocking petals 642 is tapered towards the direction close to the light path L to form a rear portion 644. According to the 6th example, a number of the light blocking petals 642 is 176.

In FIGS. 6B and 6F, the sheet shading element 620 can further include a cutting mark 624 farther away from the light path L than the first periphery 641 from the light path L, and the cutting mark 624 exposes on the optical body 610.

In FIG. 6F, the optical body 610 can further include an incident surface 613 and an exit surface 614, wherein the light path L passes through the incident surface 613, the reflecting surface 612 and the exit surface 614 in sequence, and the light path L is folded at least twice occurring in the optical body 610.

In FIGS. 6A, 6D, 6E and 6F, the optical body 610 can further include a release structure 615 and a ridge structure 616, wherein the release structure 615 is disposed on a side of the sheet shading element 620 away from the first periphery 641, the release structure 615 is tapered along an extending direction of the sheet shading element 620, and at least one portion of the sheet shading element 620 is disposed on the release structure 615. Furthermore, the release structure 615 is tapered along the directions perpendicular to the exit surface 614. The ridge structure 616 can include a plurality of recesses 661 arranged along a direction surrounding the light path L, each of the recesses 661 includes a recess end 662, the recess end 662 is corresponding to the first periphery 641 of the first light blocking structure 623, and each of the recesses 661 is gradually widened from the recess end 662 towards a direction away from the light path L.

In FIG. 6E, the ridge structure 616 can further include a plurality of ribs 663 extending from the recesses 661 towards a direction away from the light path L.

In FIG. 6G, the release structure 615 can include a first release surface 651 and a second release surface 652, wherein the first release surface 651 is gradually close to the sheet shading element 620 along the extending direction of the sheet shading element 620, the second release surface 652 is relative to the first release surface 651, and the sheet shading element 620 is disposed between the first release surface 651 and the second release surface 652.

In FIGS. 6D and 6E, the molded prism 600 can further include an opaque layer 670, wherein the opaque layer 670 is disposed on the ridge structure 616. It should be mentioned that the cross pattern in FIGS. 6D and 6E are configured to indicate the range of the opaque layer 670.

In FIGS. 6B and 6F, the first periphery 641 of the first light blocking structure 623 is closed and surrounds the light path L.

In FIGS. 60, 6E and 6G, when a distance between adjacent two of the rear portions 644 is D1; a distance between adjacent two of the recess ends 662 is D2; a thickness of the sheet shading element 620 is defined via a distance between the first surface 621 and the second surface 622, and the thickness of the sheet shading element 620 is T; a minimum distance between the first release surface 651 and the sheet shading element 620 is G1; a minimum distance between the first release surface 651 and the second release surface 652 is G12, the following conditions of Table 6 are satisfied.

TABLE 6
6th example

| | | | |
|---|---|---|---|
| D1 (mm) | 0.036 | G12 (mm) | 0.335 |
| D2 (mm) | 0.057 | T (mm) | 0.15 |
| G1 (mm) | 0.158 | T/G12 | 0.448 |

It should be mentioned that the partial structures and elements are omitted in the partial drawings for clearly indicating the relationship between the optical body 610 and the sheet shading element 620.

### 7th Example

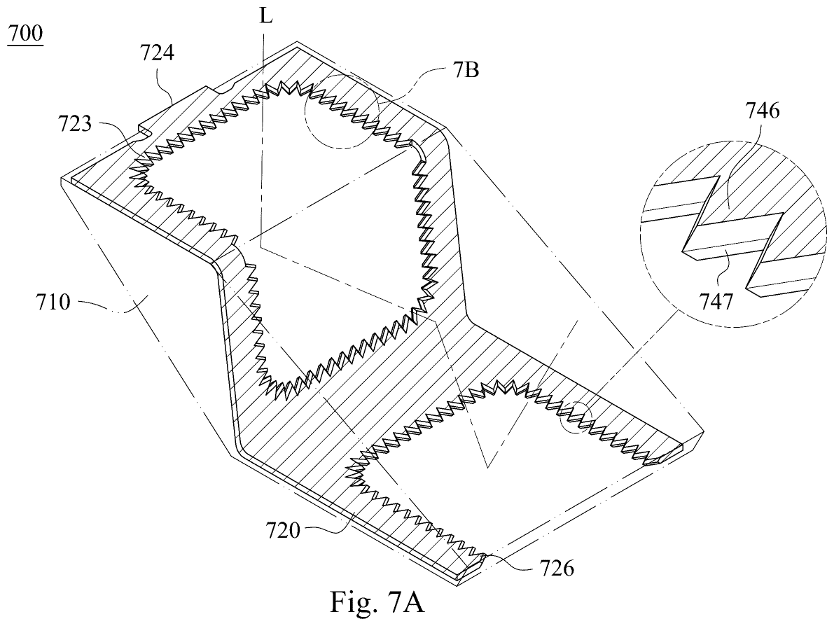

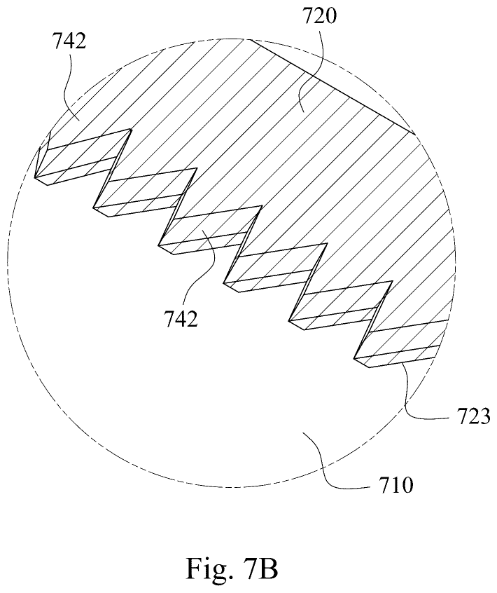

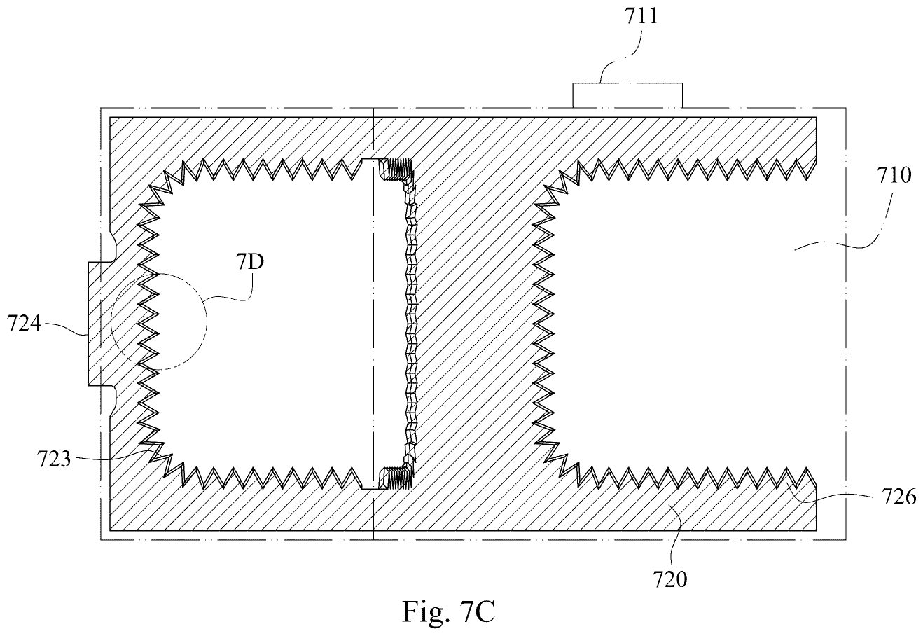

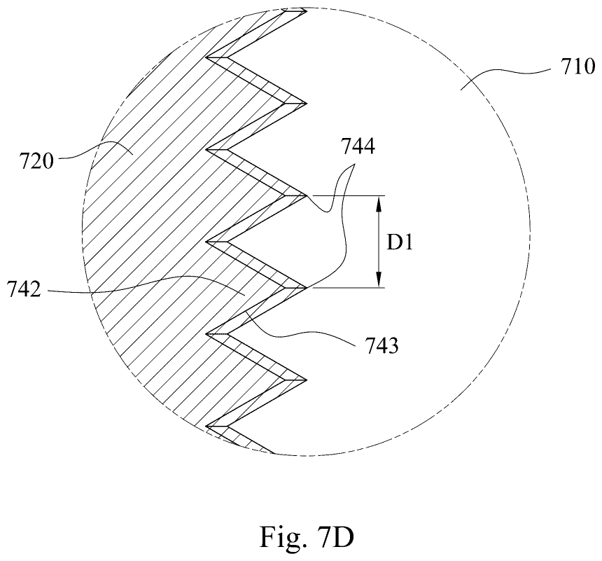

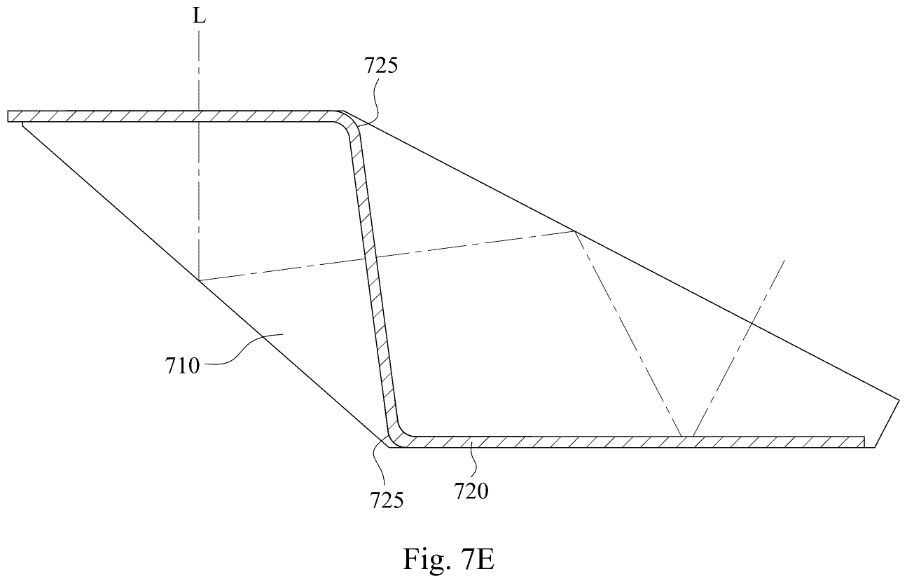

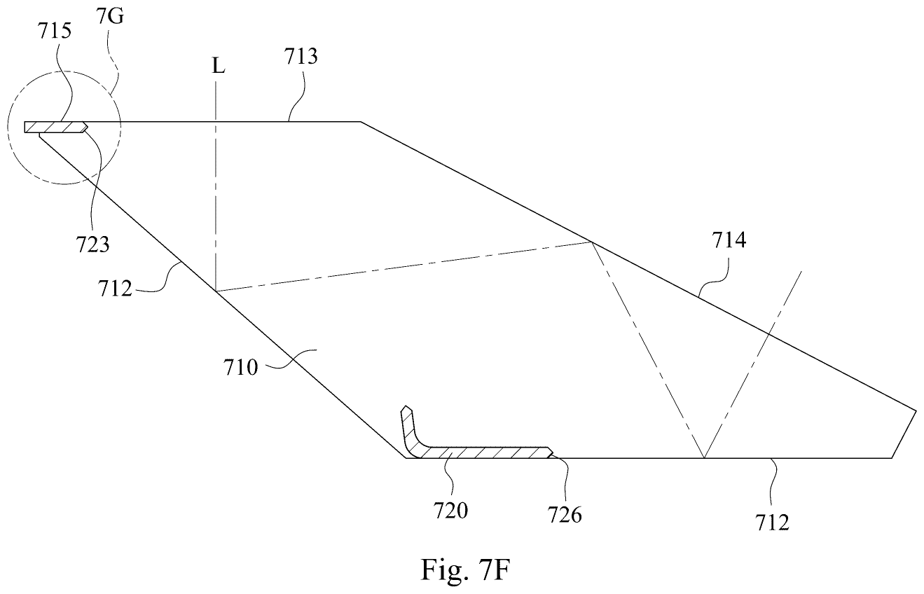

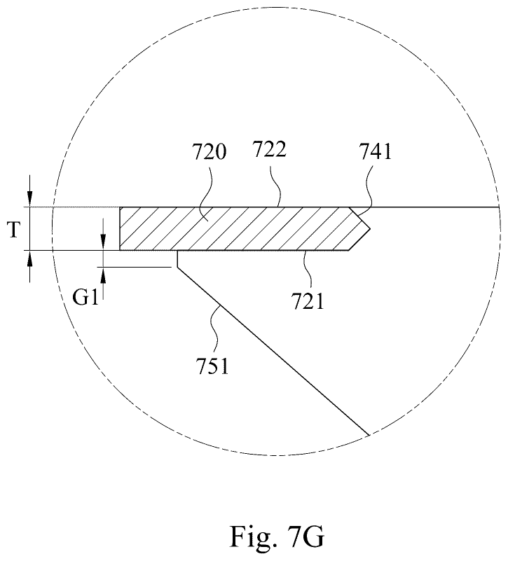

FIG. 7A is a three-dimensional view of a molded prism 700 according to the 7th example of the present disclosure, FIG. 7B is a partial enlarged view of the molded prism 700 according to the 7th example in FIG. 7A, FIG. 7C is a top view of the molded prism 700 according to the 7th example in FIG. 7A, FIG. 7D is a partial enlarged view of the molded prism 700 according to the 7th example in FIG. 7C, and FIG. 7E is a side view of the molded prism 700 according to the 7th example in FIG. 7A. In FIGS. 7A to 7E, the molded prism 700 includes an optical body 710 and a sheet shading element 720, wherein the optical body 710 has a light path L passing through the optical body 710, and the sheet shading element 720 is covered via the optical body 710.

FIG. 7F is a cross-sectional view of the molded prism 700 according to the 7th example in FIG. 7E. In FIGS. 7C and 7F, the optical body 710 includes a gate trace 711 and a reflecting surface 712, wherein the light path L is folded on the reflecting surface 712, and the light path L does not pass through the gate trace 711.

FIG. 7G is a partial enlarged view of the molded prism 700 according to the 7th example in FIG. 7F. In FIGS. 7A to 7C, 7F and 7G, the sheet shading element 720 is closer to the light path L than the gate trace 711 to the light path L, and the sheet shading element 720 includes a first surface 721, a second surface 722 and a first light blocking structure 723, wherein the second surface 722 is relative to the first surface 721, and the second surface 722 is farther away from the reflecting surface 712 than the first surface 721 from the reflecting surface 712. The first light blocking structure 723 includes a first periphery 741, wherein the first periphery 741 is connected to the first surface 721 and the second surface 722, the first periphery 741 faces towards the light path L, the first periphery 741 is closed and surrounds the light path L, and the optical body 710 is physically contacted with the first periphery 741, the first surface 721 and the second surface 722.

In FIGS. 7B and 7D, the first periphery 741 includes a plurality of light blocking petals 742, and the light blocking petals 742 are adjacently arranged, wherein each of the light blocking petals 742 of the first periphery 741 includes a tapered portion 743 tapering towards a direction close to the light path L, the light blocking petals 742 are covered inside the optical body 710, and the tapered portion 743 of each of the light blocking petals 742 is tapered towards the direction close to the light path L to form a rear portion 744. According to the 7th example, a number of the light blocking petals 742 is 72. Furthermore, a thickness of each of the light blocking petals 742 gradually increases towards a direction away from the light path L.

In FIGS. 7A and 7C, the sheet shading element 720 can further include a cutting mark 724 farther away from the light path L than the first periphery 741 from the light path L, and the cutting mark 724 exposes on the optical body 710.

In FIG. 7F, the optical body 710 can further include an incident surface 713 and an exit surface 714, wherein the light path L passes through the incident surface 713, the reflecting surface 712 and the exit surface 714 in sequence, the sheet shading element 720 extends along a direction away from the exit surface 714, and the light path L is folded at least twice occurring in the optical body 710. Furthermore, the aforementioned direction is perpendicular to the exit surface 714.

The optical body 710 can further include a release structure 715 disposed on a side of the sheet shading element 720 away from the first periphery 741, the release structure 715 is tapered along an extending direction of the sheet shading element 720, and at least one portion of the sheet shading element 720 is disposed on the release structure 715.

In FIG. 7G, the release structure 715 can include a first release surface 751, wherein the first release surface 751 is gradually close to the sheet shading element 720 along the extending direction of the sheet shading element 720.

In FIGS. 7A, 7C, 7E and 7F, the sheet shading element 720 can further include at least one bending portion 725 and a second light blocking structure 726, wherein at least one portion of the first periphery 741 is disposed on the bending portion 725, the second light blocking structure 726 includes a second periphery (its reference numeral is omitted), the second periphery is connected to the first surface 721 and the second surface 722, the second periphery faces towards the light path L, the second periphery is opened and surrounds the light path L, and the second periphery and the optical body 710 are physically contacted. The second periphery includes a plurality of light blocking petals 746, and the light blocking petals 746 are adjacently arranged, wherein each of the light blocking petals 746 of the second periphery includes a tapered portion 747 tapering towards a direction close to the light path L, and the light blocking petals 746 are covered inside of the optical body 710. According to the 7th example, a number of the light blocking petals 746 is 42.

In FIGS. 7D and 7G, when a distance between adjacent two of the rear portions 744 is D1; a thickness of the sheet shading element 720 is defined via a distance between the first surface 721 and the second surface 722, and the thickness of the sheet shading element 720 is T; a minimum distance between the first release surface 751 and the sheet shading element 720 is G1, the following conditions of Table 7 are satisfied.

TABLE 7
7th example

| | | | |
|---|---|---|---|
| D1 (mm) | 0.32 | T (mm) | 0.15 |
| G1 (mm) | 0.06 | | |

It should be mentioned that the partial structures and elements are omitted in the partial drawings for clearly indicating the relationship between the optical body 710 and the sheet shading element 720.

### 8th Example

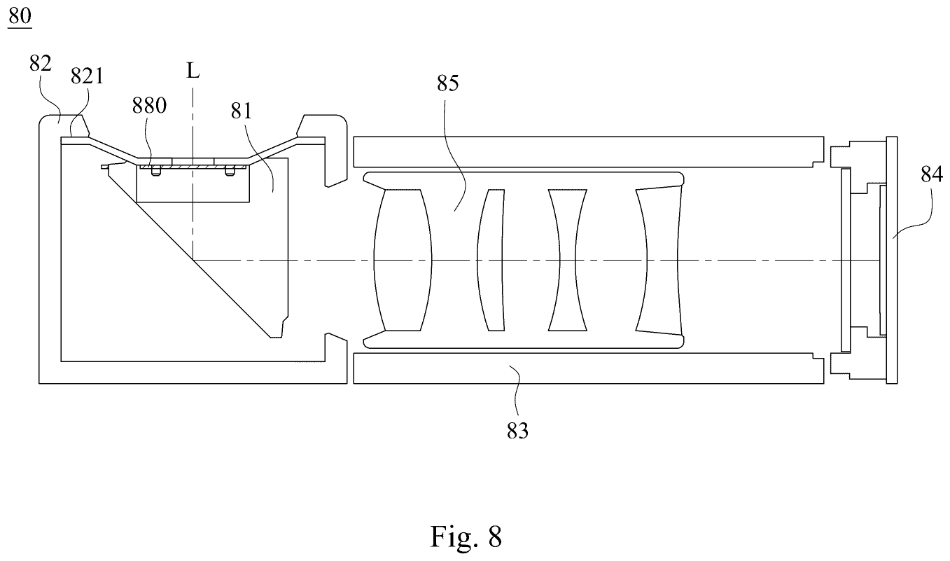

FIG. 8 is a schematic view of a camera module 80 according to the 8th example of the present disclosure. In FIG. 8, the camera module 80 includes a molded prism 81, a first carrier 82, a second carrier 83, an image sensor module 84 and a camera 85, wherein the molded prism 81 is disposed in the first carrier 82, the camera 85 is disposed in the second carrier 83, the image sensor module 84 is disposed relative to the camera 85, and an optical body (its reference numeral is omitted) of the molded prism 81 has a light path L. It should be mentioned that a number of lens element, a position, and a shape of the camera 85 are only for example, and the present disclosure is not limited thereto.

The molded prism 81 can include an exposed structure 880, wherein at least one portion of the first carrier 82 is disposed on the exposed structure 880 so as to improve the combination of the first carrier 82 and the molded prism 81, and the assembling defection can be reduced. Specifically, a connecting element 821 of the first carrier 82 is disposed on the exposed structure 880 of the molded prism 81. The aforementioned arrangement can be achieved through electric riveting, gluing, ultrasonic bonding and so on, but the present disclosure is not limited thereto. The configuration of additional carriers can be reduced through a directly connection between the exposed structure 880 and the connecting element 821.

Further, the exposed structure 280 of the molded prism 200 of the 2nd example can be relative to the exposed structure 880 of the camera module 80 of the 8th example, and the molded prism 200 of the 2nd example can be applied to the camera module 80 of the 8th example, that is the structural detail of the molded prism 200 of the 2nd example and the structural detail of the molded prism 81 of the 8th example are the same.

### 9th Example

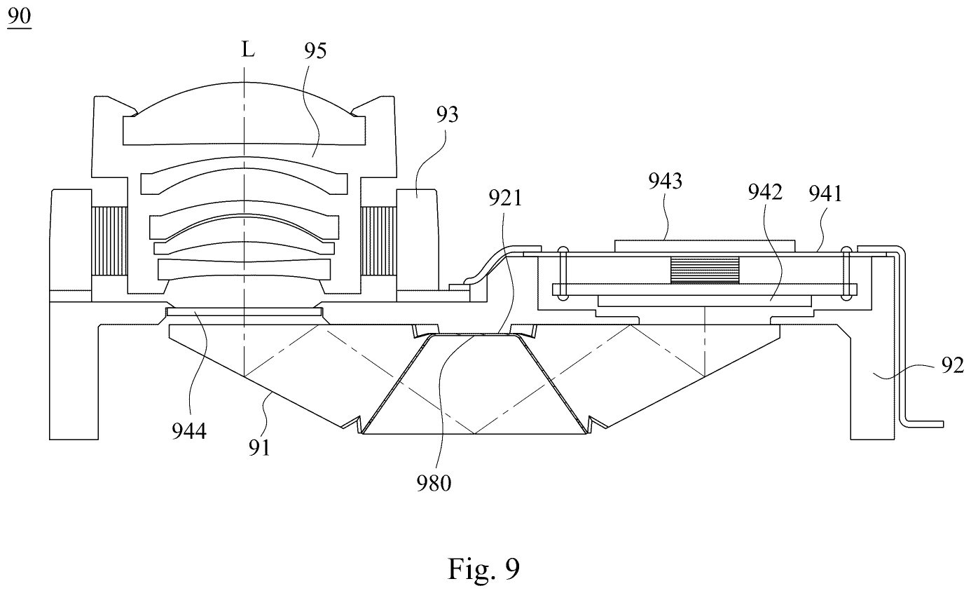

FIG. 9 is a schematic view of a camera module 90 according to the 9th example of the present disclosure. In FIG. 9, the camera module 90 includes a molded prism 91, a carrier 92, a camera driver 93, an image sensor driver 941, an image sensor 942, an image signal processor (ISP) 943, a filter element 944 and a camera 95, wherein the carrier 92 carries both of the molded prism 91 and the camera 95. The camera driver 93 is configured for the zooming function, the image sensor driver 941 is configured for providing the image stabilizing function, the image sensor driver 941 is connected to the image sensor 942 and the image signal processor 943, the filter element 944 is disposed between the camera 95 and the molded prism 91, and an optical body (its reference numeral is omitted) of the molded prism 91 has a light path L. It should be mentioned that a number of lens element, a position, and a shape of the camera 95 are only for example, and the present disclosure is not limited thereto. Further, the image sensor driver 941 can simultaneously include functions of image computing, driver collaborative computing, and heat dissipating, but the present disclosure is not limited thereto.

The molded prism 91 can include an exposed structure 980, wherein at least one portion of the carrier 92 is disposed on the exposed structure 980. In detail, the molded prism 91 is disposed on a rack 921 of the carrier 92 via the exposed structure 980. The aforementioned arrangement can be achieved through electric riveting, gluing, ultrasonic bonding and so on, but the present disclosure is not limited thereto.

Further, the molded prism 400 of the 4th example can be applied to the camera module 90 of the 9th example, that is, the structural detail of the molded prism 400 of the 4th example and the structural detail of the molded prism 91 of the 9th example are the same.

### 10th Example

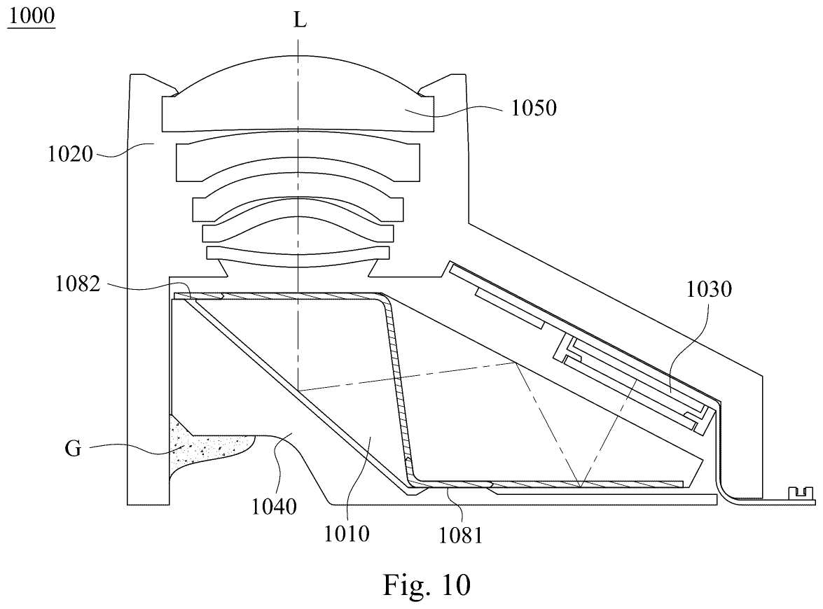

FIG. 10 is a schematic view of a camera module 1000 according to the 10th example of the present disclosure. In FIG. 10, the camera module 1000 includes a molded prism 1010, a carrier 1020, an image sensor module 1030, a retainer 1040 and a camera 1050, wherein the carrier 1020 carries all of the molded prism 1010, the image sensor module 1030 and the camera 1050 so as to reduce the geometric tolerance superposition during assembly, and an optical body (its reference numeral is omitted) of the molded prism 1010 has a light path L. It should be mentioned that a number of lens element, a position, and a shape of the camera 1050 are only for example, and the present disclosure is not limited thereto.

The molded prism 1010 can include two exposed structures 1081, 1082, wherein at least one portion of the carrier 1020 is disposed on the exposed structures 1081, 1082. In detail, the retainer 1040 is simultaneously and physically contacted with the molded prism 1010 and the exposed structures 1081, 1082, and the retainer 1040 is fixed in the carrier 1020 with an adhesive G so as to fix the molded prism 1010 in the carrier 1020.

Further, the molded prism 700 of the 7th example can be applied to the camera module 1000 of the 10th example, that is the structural detail of the molded prism 700 of the 7th example and the structural detail of the molded prism 1010 of the 10th example are the same.

### 11th Example

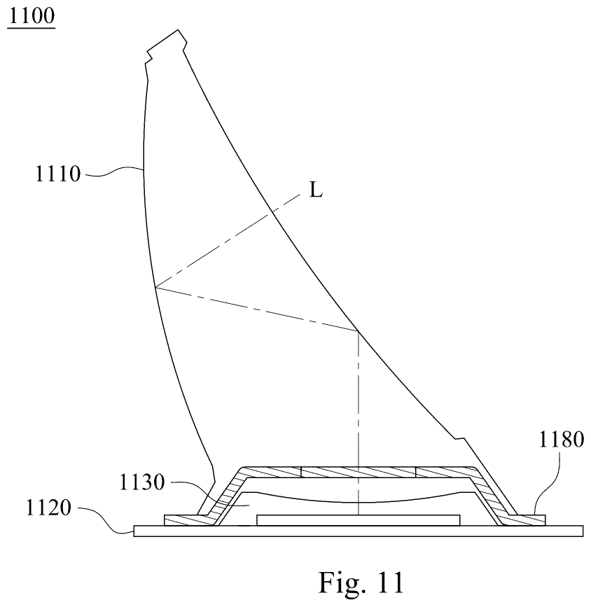

FIG. 11 is a schematic view of a camera module 1100 according to the 11th example of the present disclosure. In FIG. 11, the camera module 1100 includes a molded prism 1110, a carrier 1120 and an electric element 1130, wherein the carrier 1120 carries the molded prism 1110 and the electric element 1130, and an optical body (its reference numeral is omitted) of the molded prism 1110 has a light path L.

In detail, the sheet shading element (its reference numeral is omitted) of the molded prism 1110 can be disposed on the carrier 1120 so as to have the light blocking function. Moreover, the carrier 1120 can further provide the functions of supporting and shielding, and the carrier 1120 can further carry the electric element 1130, wherein the electric element 1130 can be an image sensor, computing element and passive element, but the present disclosure is not limited thereto.

The molded prism 1110 can include an exposed structure 1180, wherein at least one portion of the carrier 1120 is disposed on the exposed structure 1180.

Further, the molded prism 600 of the 6th example can be applied to the camera module 1100 of the 11th example, that is the structural detail of the molded prism 600 of the 6th example and the structural detail of the molded prism 1110 of the 11th example are the same.

### 12th Example

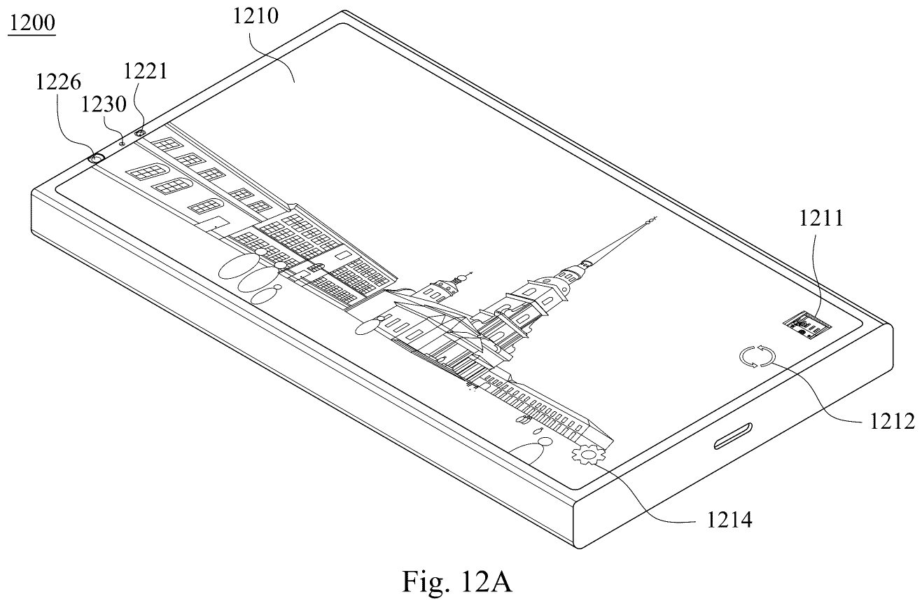

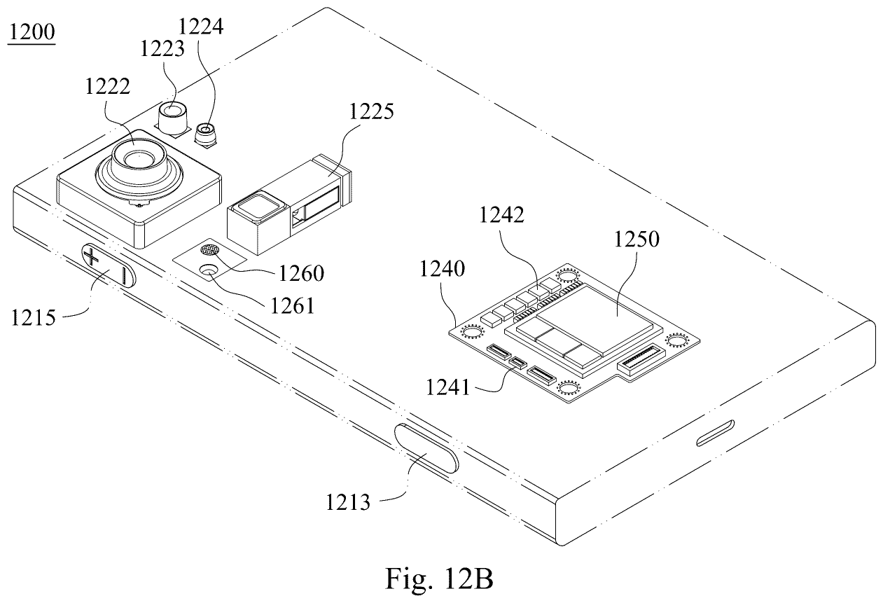

FIG. 12A is a schematic view of an electronic device 1200 according to the 12th example of the present disclosure, and FIG. 12B is another schematic view of the electronic device 1200 according to the 12th example in FIG. 12A. In FIGS. 12A and 12B, the electronic device 1200 is a smartphone, and the electronic device 1200 includes a camera module and an image-capturing control interface 1210, wherein the camera module includes a molded prism. Moreover, each of the molded prism can be the molded prisms according to the aforementioned 1st example to the 11th example, but the present disclosure is not limited thereto.

According to the 12th example, the camera modules are a front camera module 1221, a wide angle camera module 1222, a ultra-wide angle camera module 1223, a micro camera module 1224, a telephoto camera module 1225 and a Time-Of-Flight (TOF) module 1226, wherein the TOF module 1226 can be another camera modules with other functions, but the disposition is not limited thereto.

In detail, according to the 12th example, the front camera module 1221 and the TOF module 1226 are disposed on a front of the electronic device 1200, and the wide angle camera module 1222, the ultra-wide angle camera module 1223, the micro camera module 1224 and the telephoto camera module 1225 are disposed on a back of the electronic device 1200.

The image-capturing control interface 1210 can be a touch screen for displaying the scene and having the touch function, and the shooting angle can be manually adjusted. In detail, the image-capturing control interface 1210 includes an image replay button 1211, a camera module switching button 1212, a focus capturing button 1213, an integrated menu button 1214 and a zoom control button 1215. Furthermore, users enter a shooting mode via the image-capturing control interface 1210 of the electronic device 1200, the camera module switching button 1212 can be flexibly configured to switch one of the front camera module 1221, the wide angle camera module 1222, the ultra-wide angle camera module 1223, the micro camera module 1224 and the telephoto camera module 1225 to capture the image, the zoom control button 1215 is configured to adjust the zoom, the focus capturing button 1213 is configured to be undergo image capturing after capturing the images and confirming one of the front camera module 1221, the wide angle camera module 1222, the ultra-wide angle camera module 1223, the micro camera module 1224 and the telephoto camera module 1225 to capture the image, the users can view the images by the image replay button 1211 after undergoing image capturing, and the integrated menu button 1214 is configured to adjust the details of the image capturing (such as timed photo, photo ratio, and etc.).

The electronic device 1200 can further include a reminding light 1230, the reminding light 1230 is disposed on the front of the electronic device 1200, and the reminding light 1230 can be configured to remind the users of unread messages, missed calls and the condition of the phone.

Moreover, after entering the shooting mode via the image-capturing control interface 1210 of the electronic device 1200, the imaging light is gathered on the image sensor via the camera module, and an electronic signal about an image is output to an image signal processor (its reference numeral is omitted) of a single chip system 1250. The single chip system 1250 can further include a random access memory (RAM) (its reference numeral is omitted), a central processing unit (its reference numeral is omitted) and a storage unit (its reference numeral is omitted). Also, the single chip system 1250 can further include, but not be limited to, a display, a control unit, a read-only memory (ROM), or the combination thereof.

Further, the electronic device 1200 can further include an image software processor and an image signal processor, and further integrates the image software processor, the image signal processor, a position locator, a transmit signal processor, a gyroscope, a storage unit and a random access memory in the single chip system 1250.

To meet a specification of the electronic device 1200, the electronic device 1200 can further include an optical anti-shake mechanism (not shown). Furthermore, the electronic device 1200 can further include at least one focusing assisting module 1260 and at least one sensing element (not shown). The focusing assisting module 1260 can include a flash element 1261 for compensating a color temperature, an infrared distance measurement component (not shown), a laser focus module (not shown), etc. The sensing element can have functions for sensing physical momentum and kinetic energy, such as an accelerator, a gyroscope, a Hall Effect Element, a position locator, a signal transmitter module, to sense shaking or jitters applied by hands of the user or external environments. Accordingly, the electronic device 1200 equipped with an auto-focusing mechanism and the optical anti-shake mechanism can be enhanced to achieve the superior image quality. Furthermore, the electronic device 1200 according to the present disclosure can have a capturing function with multiple modes, such as taking optimized selfies, high dynamic range (HDR) under a low light condition, 4K resolution recording, etc. Furthermore, the users can visually see a captured image of the camera through the image-capturing control interface 1210 and manually operate the view finding range on the image-capturing control interface 1210 to achieve the autofocus function of what you see is what you get.

Moreover, the camera module, the optical anti-shake mechanism, the sensing element, the focusing assisting module 1260 and an electronic element 1242 can be disposed on a circuit board 1240 and electrically connected to the associated components via a connector 1241 to perform a capturing process, wherein the circuit board 1240 can be a flexible printed circuit board (FPC). Since the current electronic devices, such as smart phones, have a tendency of being compact, the way of firstly disposing the camera module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the image capturing apparatus can also be controlled more flexibly via the touch screen of the electronic device. According to the 12th example, the sensing element and the focusing assisting module 1260 are disposed on the circuit board 1240 and at least one other flexible printed circuit board (not shown) and electrically connected to the associated components, such as the image signal processor, via corresponding connectors to perform the capturing process. In other examples (not shown), the sensing elements and the focusing assisting modules can also be disposed on the main board of the electronic device or carrier boards of other types according to requirements of the mechanical design and the circuit layout.

Moreover, the image of the certain range with the high resolution can be captured via the wide angle camera module 1222, and the wide angle camera module 1222 has the function of the high resolution and the low deformation. Comparing with the image captured via the wide angle camera module 1222, the image captured via the telephoto camera module 1225 has narrower visual angle and narrower depth of field. Hence, the telephoto camera module 1225 can be configured to capture the moving targets, that is, the telephoto camera module 1225 can be driven via an actuator (not shown) of the electronic device 1200 to quick and continuous auto focus the moving targets so as to make the image of the moving targets is not fuzzy owing to defocus. Comparing with the image captured via the wide angle camera module 1222, the image captured via the ultra-wide angle camera module 1223 has wider visual angle and wider depth of field, but the image captured via the ultra-wide angle camera module 1223 also has greater distortion.

In particular, the zooming function can be obtained via the electronic device 1200, when the scene is captured via the camera module with different focal lengths cooperated with the function of image processing.

### 13th Example

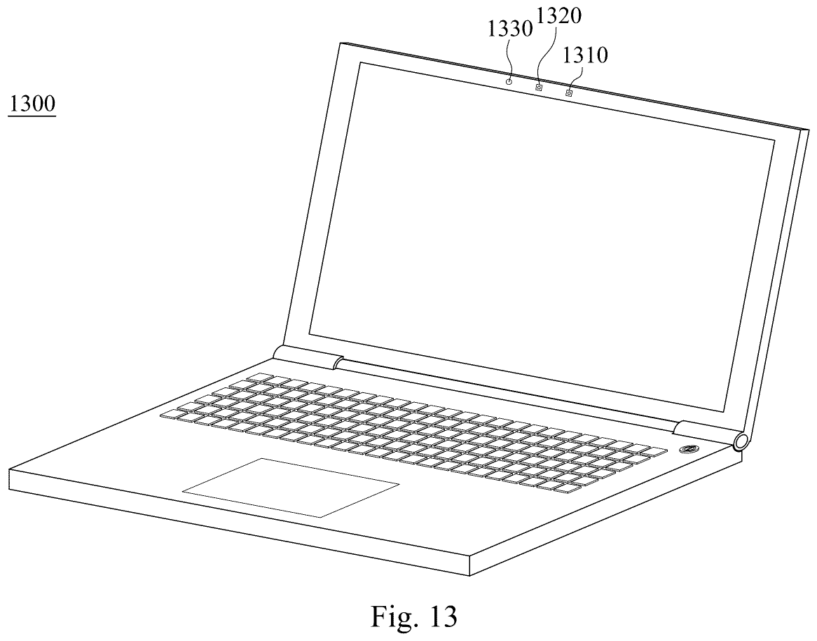

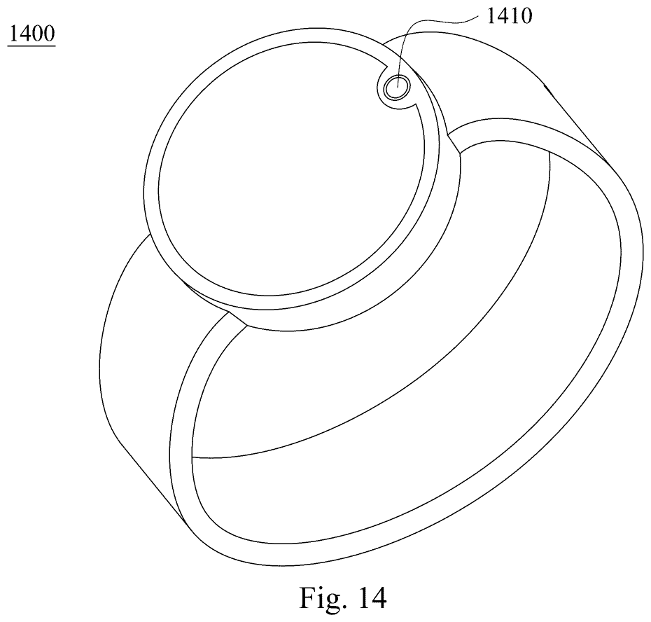

FIG. 13 is a schematic view of an electronic device applied to a computer 1300 according to the 13th example of the present disclosure. In FIG. 13, the electronic device (its reference numeral is omitted) includes a camera module and an infrared transmitter module 1330, wherein the camera module includes a molded prism. Moreover, each of the molded prism can be the molded prisms according to the aforementioned 1st example to the 11th example, but the present disclosure is not limited thereto.

According to the 13th example, the camera modules are a webcam camera module 1310 and an infrared camera module 1320, and the infrared camera module 1320 is configured to the space recognition, the distance measurement and so on.

### 14th Example

FIG. 14 is a schematic view of an electronic device applied to a wearable device 1400 according to the 14th example of the present disclosure. In FIG. 14, the electronic device (its reference numeral is omitted) includes a camera module, wherein the camera module includes a molded prism. Moreover, the molded prism can be the molded prisms according to the aforementioned 1st example to the 11th example, but the present disclosure is not limited thereto.

According to the 14th example, the camera module is a webcam camera module 1410.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A molded prism, comprising:
an optical body, having a light path passing through the optical body, and comprising:
a reflecting surface, the light path folded on the reflecting surface; and
a gate trace, the light path not passing through the gate trace; and
a sheet shading element covered via the optical body, wherein the sheet shading element is closer to the light path than the gate trace to the light path, and the sheet shading element comprises:
a first surface;
a second surface relative to the first surface, and the second surface farther away from the reflecting surface than the first surface from the reflecting surface; and
a first light blocking structure, comprising:
a first periphery connected to the first surface and the second surface, the first periphery facing towards the light path, the first periphery surrounding the light path, and the optical body physically contacted with the first periphery, the first surface and the second surface;
wherein the first periphery comprises a plurality of light blocking petals, a number of the light blocking petals of the first periphery is between 14 and 250, and the light blocking petals are adjacent arranged;
wherein each of the light blocking petals of the first periphery comprises a tapered portion tapering towards a direction close to the light path, and the light blocking petals are covered inside the optical body.

2. The molded prism of claim 1, wherein the tapered portion of each of the light blocking petals is tapered towards the direction close to the light path to form a rear portion;
wherein a distance between adjacent two of the rear portions is D1, and the following condition is satisfied:
$$0.018 mm \leq D 1 \leq 0.8 mm .$$

3. The molded prism of claim 2, wherein the distance between the adjacent two of the rear portions is D1, and the following condition is satisfied:
0.02 mm≤D1≤0.6 mm.

4. The molded prism of claim 1, wherein a thickness of the sheet shading element is defined via a distance between the first surface and the second surface, the thickness of the sheet shading element is T, and the following condition is satisfied:
$$0.03 mm \leq T \leq 0.5 mm .$$

5. The molded prism of claim 1, wherein the sheet shading element further comprises:
a cutting mark farther away from the light path than the first periphery from the light path, and the cutting mark exposing on the optical body.

6. The molded prism of claim 1, wherein the optical body further comprises:
a release structure disposed on a side of the sheet shading element away from the first periphery, wherein the release structure is tapered along an extending direction of the sheet shading element, and at least one portion of the sheet shading element is disposed on the release structure;
wherein the release structure comprises a first release surface gradually close to the sheet shading element along the extending direction of the sheet shading element, a minimum distance between the first release surface and the sheet shading element is G1, and the following condition is satisfied:
$$0.03 mm \leq G 1 \leq 0.24 mm .$$

7. The molded prism of claim 6, wherein the release structure further comprises:
a second release surface relative to the first release surface, and the sheet shading element disposed between the first release surface and the second release surface;
wherein a minimum distance between the first release surface and the second release surface is G12; a thickness of the sheet shading element is defined via a distance between the first surface and the second surface, the thickness of the sheet shading element is T, and the following condition is satisfied:
$$0.15 \leq T / G 12 \leq 0.68 .$$

8. The molded prism of claim 1, wherein the optical body further comprises an incident surface and an exit surface, and the light path passes through the incident surface, the reflecting surface and the exit surface in sequence;
wherein the sheet shading element extends along a direction away from one of the incident surface, the reflecting surface and the exit surface.

9. The molded prism of claim 8, wherein the direction is perpendicular to the one of the incident surface, the reflecting surface and the exit surface.

10. The molded prism of claim 1, wherein the optical body further comprises:
a ridge structure comprising a plurality of recesses arranged along a direction surrounding the light path, wherein each of the recesses comprises a recess end, the recess end is corresponding to the first periphery of the first light blocking structure, and each of the recesses is gradually widened from the recess end towards a direction away from the light path;
wherein a distance between adjacent two of the recess ends is D2, and the following condition is satisfied:
$$0.028 mm \leq D 2 \leq 0.6 mm .$$

11. The molded prism of claim 10, wherein the distance between the adjacent two of the recess ends is D2, and the following condition is satisfied:
$$0.038 mm \leq D 2 \leq 0.45 mm .$$

12. The molded prism of claim 10, further comprising:
an opaque layer disposed on the ridge structure.

13. The molded prism of claim 10, wherein the ridge structure further comprises:
a plurality of ribs extending from the recesses towards a direction away from the light path.

14. The molded prism of claim 1, wherein the sheet shading element further comprises:
at least one bending portion, at least one portion of the first periphery disposed on the at least one bending portion.

15. The molded prism of claim 1, wherein the sheet shading element further comprises:
a second light blocking structure comprising a second periphery, wherein the second periphery is connected to the first surface and the second surface, the second periphery faces towards the light path, the second periphery surrounds the light path, and the second periphery and the optical body are physically contacted;
wherein the second periphery comprises a plurality of light blocking petals, a number of the light blocking petals of the second periphery is between 14 and 250, and the light blocking petals are adjacently arranged;
wherein each of the light blocking petals of the second periphery comprises a tapered portion tapering towards a direction close to the light path, and the light blocking petals are covered inside of the optical body.

16. The molded prism of claim 1, wherein a number of the sheet shading element is plurality.

17. The molded prism of claim 1, wherein a thickness of each of the light blocking petals gradually increases towards a direction away from the light path.

18. The molded prism of claim 1, wherein the light path is folded at least twice occurring in the optical body.

19. The molded prism of claim 1, wherein the optical body further comprises:
an anti-reflecting surface, the light path passing through the anti-reflecting surface;
wherein a maximum reflectivity of the anti-reflecting surface in a wavelength range of 450 nm to 750 nm is less than or equal to 0.49%.

20. The molded prism of claim 1, wherein an infrared light is partially filtered via the molded prism, and a wavelength providing a transmittance of the molded prism being 50% is between 600 nm and 700 nm.

21. A camera module, comprising:
the molded prism of claim 1.

22. The camera module of claim 21, further comprising:
a carrier;
wherein the molded prism further comprises an exposed structure, the sheet shading element is exposed on the exposed structure to the optical body, and at least one portion of the carrier is disposed on the exposed structure.

23. An electronic device, comprising:
the camera module of claim 21.

24. A molded prism, comprising:
an optical body, having a light path passing through the optical body, and comprising:
a reflecting surface, the light path folded on the reflecting surface; and
a gate trace, the light path not passing through the gate trace; and
a sheet shading element covered via the optical body, wherein the sheet shading element is closer to the light path than the gate trace to the light path, and the sheet shading element comprises:
a first surface;
a second surface relative to the first surface, and the second surface farther away from the reflecting surface than the first surface from the reflecting surface; and
a first light blocking structure, comprising:
a first periphery connected to the first surface and the second surface, the first periphery facing towards the light path, the first periphery surrounding the light path, and the optical body physically contacted with the first periphery, the first surface and the second surface;
wherein the optical body further comprises a release structure disposed on a side of the sheet shading element away from the first periphery, and the release structure is tapered along an extending direction of the sheet shading element;
wherein at least one portion of the sheet shading element is disposed on the release structure.

25. The molded prism of claim 24, wherein the release structure comprises a first release surface gradually close to the sheet shading element along an extending direction of the sheet shading element, a minimum distance between the first release surface and the sheet shading element is G1, and the following condition is satisfied:
$$0.02 mm \leq G 1 \leq 0.32 mm .$$

26. The molded prism of claim 24, wherein the release structure comprises:
a first release surface; and
a second release surface relatively disposed to the first release surface, and the sheet shading element disposed between the first release surface and the second release surface;
wherein a minimum distance between the first release surface and the second release surface is G12; a thickness of the sheet shading element is defined by a distance between the first surface and the second surface, the thickness of the sheet shading element is T, and the following condition is satisfied:
$$0.12 \leq T / G 12 \leq 0.91 .$$

27. The molded prism of claim 24, wherein the optical body further comprises an incident surface and an exit surface, and the light path passes through the incident surface, the reflecting surface and the exit surface in sequence;
wherein the sheet shading element extends along a direction away from one of the incident surface, the reflecting surface and the exit surface, and the release structure is tapered on the direction.

28. The molded prism of claim 24, wherein the release structure comprises:
a ridge structure comprising a plurality of recesses arranged along a direction surrounding the light path, wherein each of the recesses comprises a recess end, the recess end is corresponding to the first periphery of the first light blocking structure, and each of the recesses is gradually widened from the recess end towards a direction away from the light path;
wherein a distance between adjacent two of the recess ends is D2, and the following condition is satisfied:
$$0.028 mm \leq D 2 \leq 0.6 mm .$$

29. The molded prism of claim 28, wherein the ridge structure further comprises:
a plurality of ribs extending from the recesses towards a direction away from the light path.

30. The molded prism of claim 24, wherein the sheet shading element further comprises:
a cutting mark farther away from the light path than the first periphery from the light path, and the cutting mark exposing on the optical body.

31. The molded prism of claim 24, wherein the sheet shading element further comprises:
at least one bending portion, at least one portion of the first periphery disposed on the at least one bending portion.

32. The molded prism of claim 24, wherein the sheet shading element further comprises:
a second light blocking structure comprising a second periphery, wherein the second periphery is connected to the first surface and the second surface, the second periphery faces towards the light path, the second periphery surrounds the light path, and the second periphery and the optical body are physically contacted.

33. The molded prism of claim 24, wherein the optical body further comprises:
at least one anti-reflecting surface, wherein a maximum reflectivity of the at least one anti-reflecting surface in a wavelength range of 450 nm to 750 nm is less than or equal to 0.49%.

34. The molded prism of claim 24, wherein an infrared light is partially filtered via the molded prism, and a wavelength providing a transmittance of the molded prism being 50% is between 600 nm and 700 nm.

35. The molded prism of claim 24, further comprising:
an exposed structure, wherein the sheet shading element is exposed on the exposed structure to the optical body, and the exposed structure is tapered in a direction away from the exposed structure.
